(19) United States
(12) Patent Application Publication
(10) Pub. No.: US 2020/0293024 A1
(43) Pub. Date: Sep. 17, 2020

(54) DIGITAL MANUFACTURING PLATFORM

(71) Applicant: mything GmbH, Graz (AT)

(72) Inventors: Gerhard Pail, Graz (AT); Frank Kappe, Graz (AT)

(21) Appl. No.: 16/659,867

(22) Filed: Oct. 22, 2019

Related U.S. Application Data
(60) Provisional application No. 62/819,373, filed on Mar. 15, 2019.

(51) Int. Cl. G05B 19/4099; G06F 17/50; G06Q 30/02; G06Q 30/06

(52) U.S. Cl. CPC G05B 19/4099; G06F 17/5086; G05B 2219/49007; G06Q 30/0621; G06Q 30/0283

(57) ABSTRACT

An on-demand digital manufacturing platform receives digital design files for a product and analyzes producibility of the product by at least one digital manufacturing technology based on whether a set of attributes of the digital design files satisfies producibility requirements for the manufacturing technology. If the attributes do not satisfy the producibility requirements, the platform generates a modified digital design that satisfies the producibility requirements. A customer can place an order for the product from the platform. In response, the platform selects a target fabrication machine to manufacture the product. The target fabrication machine can be selected based at least in part on a determined match between specifications of the target fabrication machine and fabrication parameters that are associated with manufacturing of the product based on the modified digital design. The modified design can then be sent to the target fabrication machine to manufacture the product.

### CROSS-REFERENCE TO RELATED APPLICATION

This application claims the benefit of U.S. Provisional Patent Application No. 62/819,373, filed Mar. 15, 2019, which is incorporated herein by reference in its entirety.

### TECHNICAL FIELD

This disclosure relates to a digital manufacturing platform.

### BACKGROUND

Digital fabrication technologies, such as three-dimensional printing, two-dimensional laser cutting, 3D knitting, or computer numerical control (CNC) milling, enable a computer-controlled machine to produce an object based on a digital design. Digital fabrication technologies are becoming an increasingly more popular method for manufacturing objects. However, it is currently difficult for consumers, who may or may not have access to digital fabrication machines, to access high-quality designs and to manufacture customized products based on these designs. It is also difficult for designers who create digital designs to reach a customer base that is able to use their designs.

### BRIEF DESCRIPTION OF THE DRAWINGS

FIG. 1 illustrates an environment in which an example digital manufacturing platform operates.

FIG. 2 is a flowchart illustrating an overall process performed by the digital manufacturing platform to manage a three-sided digital manufacturing marketplace.

FIGS. 3A-3B are flowcharts illustrating various embodiments of a method for processing uploaded designs.

FIGS. 3C-3J are example user interfaces illustrating a process for uploading designs.

FIGS. 4A-4N illustrate a process used by a manufacturer to register with the digital manufacturing platform as a provider of manufacturing services.

FIGS. 5A-5B illustrate example factors used by a digital manufacturing platform to calculate a price for a digitally fabricated product.

FIG. 6A is a flowchart illustrating an example process for receiving a product order from a customer.

FIG. 6B is a flowchart illustrating an example process by which a customer may complete a product order.

FIG. 6C is a flowchart illustrating another example process for a customer to complete a product order.

FIG. 7A is a flowchart illustrating an example method for registering a machine to a digital manufacturing platform.

FIG. 7B is a flowchart illustrating an example process for fulfilling a product order.

FIG. 7C is a flowchart illustrating an example process for fulfilling a product order.

FIG. 8 is a block diagram illustrating an example processing system in which at least some operations described herein can be implemented.

### DETAILED DESCRIPTION

System Overview

An on-demand digital manufacturing platform manages a three-sided digital manufacturing marketplace. Product designers can upload designs to the platform, where customers can browse the designs for desired products. When a customer purchases a product, the digital manufacturing platform sends the design to a manufacturer to produce the product based on the design. The digital manufacturing platform can facilitate production of items using any of a variety of digital manufacturing techniques, such as 3D printing or other types of additive manufacturing, laser cutting, 3D knitting, or CNC milling. The platform allows customers to purchase customized products on-demand that are either shipped to the customer or made available for the customer to pick up at a convenient location, increasing accessibility of digital manufacturing technology for average consumers. Designers are able to reach new customers through the platform, enabling the designers to earn revenue for their digital designs. Manufacturers who own one or more digital fabrication machines earn revenue for manufacturing products ordered through the platform.

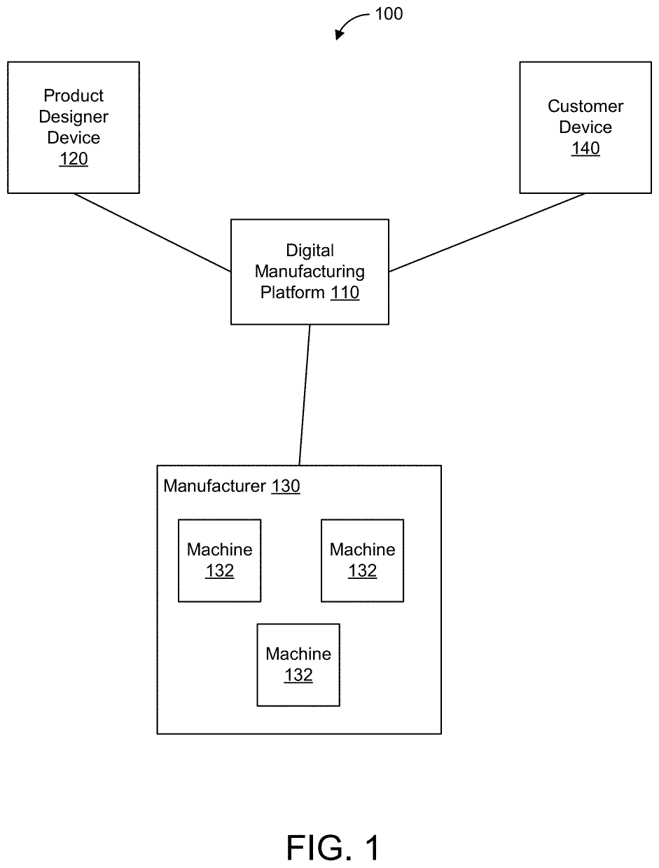

FIG. 1 illustrates an environment 100 in which a digital manufacturing platform operates. As shown in FIG. 1, the environment 100 can include the digital manufacturing platform 110, a product designer device 120, a manufacturer system 130, and a customer device 140. The environment can include additional or different components in other embodiments. For example, the environment 100 can include numerous product designer devices 120, manufacturer systems 130, and/or customer devices 140, or one more of the platform 110, designer device 120, manufacturer system 130, or customer device 140 may be the same device. The devices and systems shown in FIG. 1 can communicate over one or more public or private networks, such as the Internet.

The product designer device 120 is a computing device used by a product designer to upload designs to the digital manufacturing platform 110. The designer device 120 can be any computing device capable of communicating with the platform 110 (e.g., over the Internet), such as a desktop computer, laptop computer, tablet, or mobile phone. In some cases, a product designer can use the product designer device 120 to create a digital design using, for example, a computer-aided design (CAD) tool.

The manufacturer system 130 includes one or more computing devices used by a manufacturer to register with the digital manufacturing platform 110 to manufacture designs, receive designs from the platform 110, and/or communicate data regarding ongoing or completed manufacturing projects to the platform 110. The manufacturer system 130 is associated with a manufacturer, representing an organization or company that has one or more digital manufacturing machines 132, such as a 3D printer, a laser cutter, a 3D knitter, or a CNC mill, that can be used to fabricate designs from the platform 110. The manufacturer can register each machine to the platform 110 by specifying capabilities and availability of the machine. The capabilities of the machines 132 can include information such as a technology used by the machine. For example, a 3D printer may use a technology such as stereolithograhy (SLA), selective laser sintering (SLS), multi jet fusion (MJF), or fused deposition modeling (FDM). Other machine capabilities can include maximum or minimum size of objects that can be produced or resolution of features. In some cases, the platform 110 provides the manufacturer 130 with one or more test objects to be fabricated by each machine. The test objects can be used to verify the capabilities of the machine 132, and, once a test object has been approved, the machine 132 can be registered to fabricate products ordered through the platform 110.

In some cases, the manufacturing system 130 can communicate with one or more of the machines 132 to pass information between the digital manufacturing platform 110 and the machines 132. For example, the manufacturing system 130 can transmit a design to a machine 132 to direct the machine to fabricate the design. The manufacturing system 130 can also receive data describing the fabrication process from the machine 132, including an amount of time to produce the design or an amount of material used. In other cases, a user of the manufacturing system 130 can manually submit designs to the machines 132 and manually enter fabrication data into the manufacturing system 130 for transmission to the platform 110. In still other embodiments, the machines 132 can communicate directly with the platform 110 (for example, via an application programming interface (API)).

The environment 100 can include numerous manufacturers, each having one or more digital fabrication machines 132 that are registered on the platform 110 for manufacturing products ordered through the platform.

The customer device 140 is used by a customer to browse and purchase designs on the platform 110.

The digital manufacturing platform 110 interfaces between the product designer device 120, the manufacturer 130, and the customer device 140 to manage a three-sided digital manufacturing marketplace. Designers can upload designs to the platform 110, which processes the designs to ensure that they can be produced by at least one type of digital fabrication. Customers can browse the designs on the platform 110, for example through a storefront website maintained by the platform 110. The customers can optionally customize a design, selecting parameters such as material, color, and size of a product to be produced based on the design. The customer can also select a manufacturer, optionally choosing a manufacturer from a list generated by the platform 110 based on one or more criteria. When a customer orders a product, the platform 110 can send the design to the manufacturer to fabricate the product.

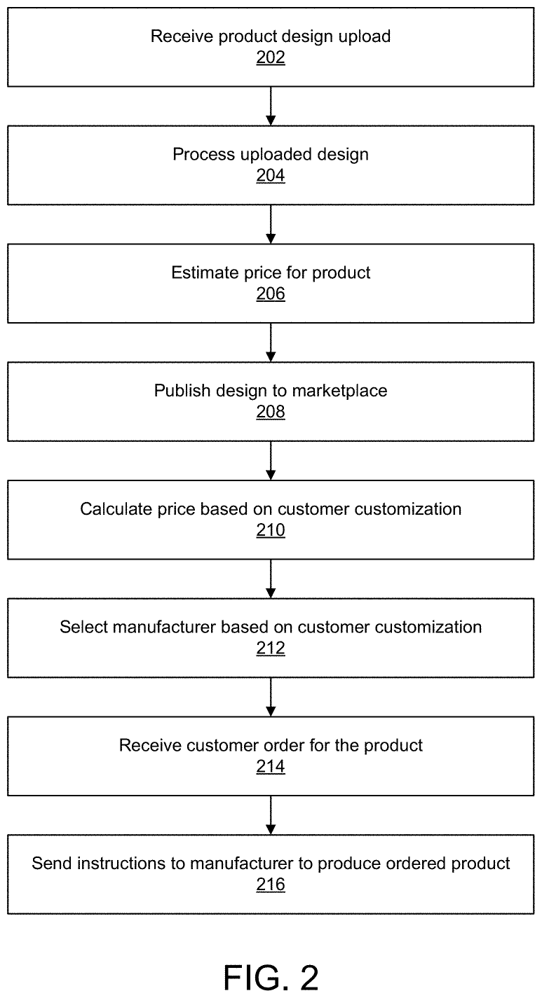

FIG. 2 is a flowchart illustrating an overall process performed by the digital manufacturing platform 110 to manage the three-sided digital manufacturing marketplace.

As shown in FIG. 2, the platform 110 receives 202 a product design upload from a product designer device 120. The uploaded product design can include one or more digital design files, which together define a digital design. The product designer may upload design files in any of a variety of formats. For example, the product designer can provide a 3D printer file that includes a model of a product and instructions enabling a 3D printer to print the product. The product designer can instead provide a 3D file that includes a model of a product without the instructions for a 3D printer. In other cases, the designer can upload a parametric design that includes one or more constraints on a product and one or more parameters that can be selected by a customer. The file uploaded by the designer device 120 can include a single object or multiple objects. For example, the file can include multiple sizes of the same object, multiple pieces that can be assembled after printing into a single object, or multiple separate objects.

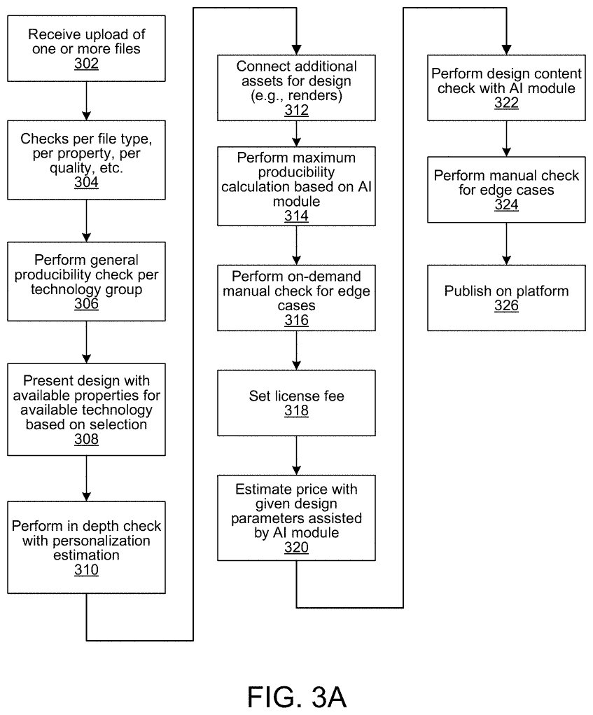

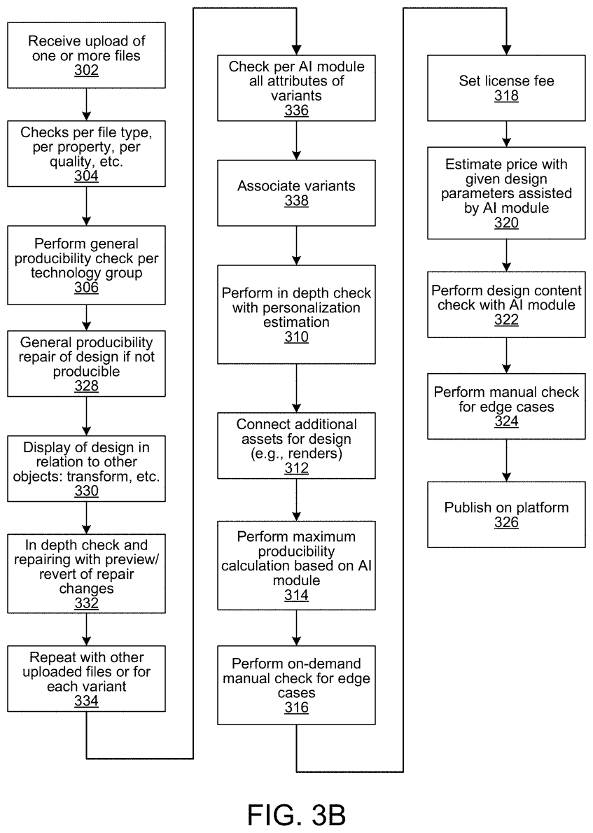

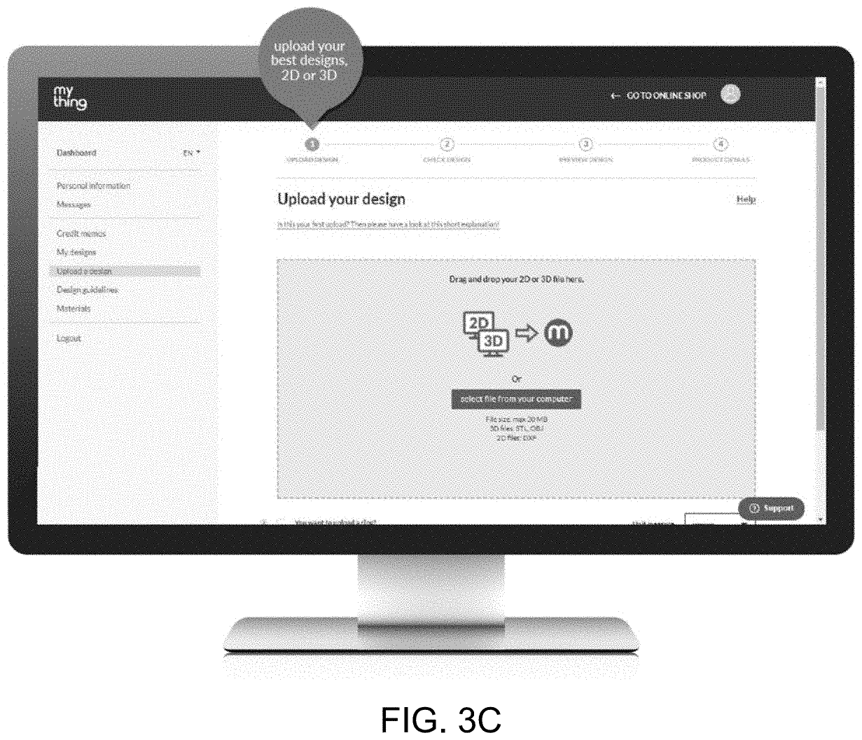

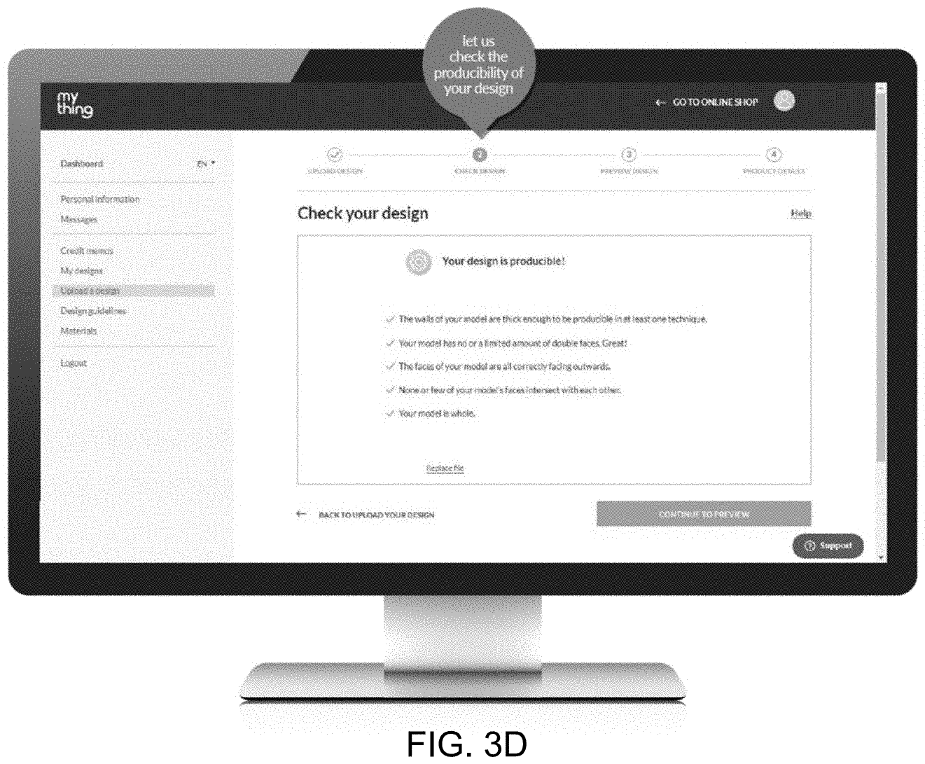

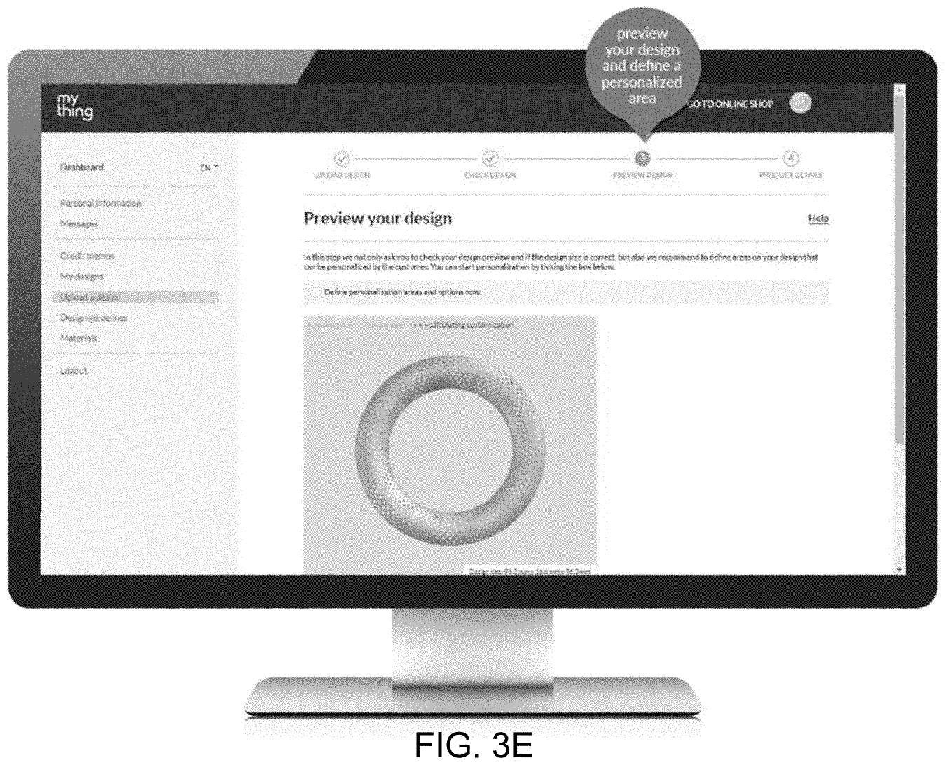

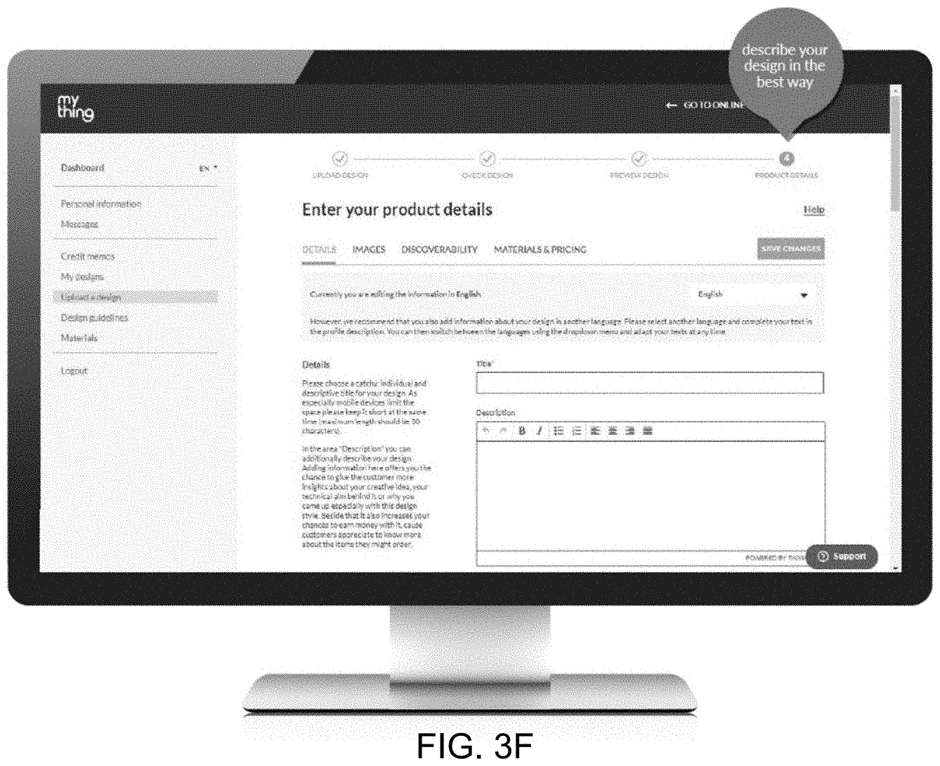

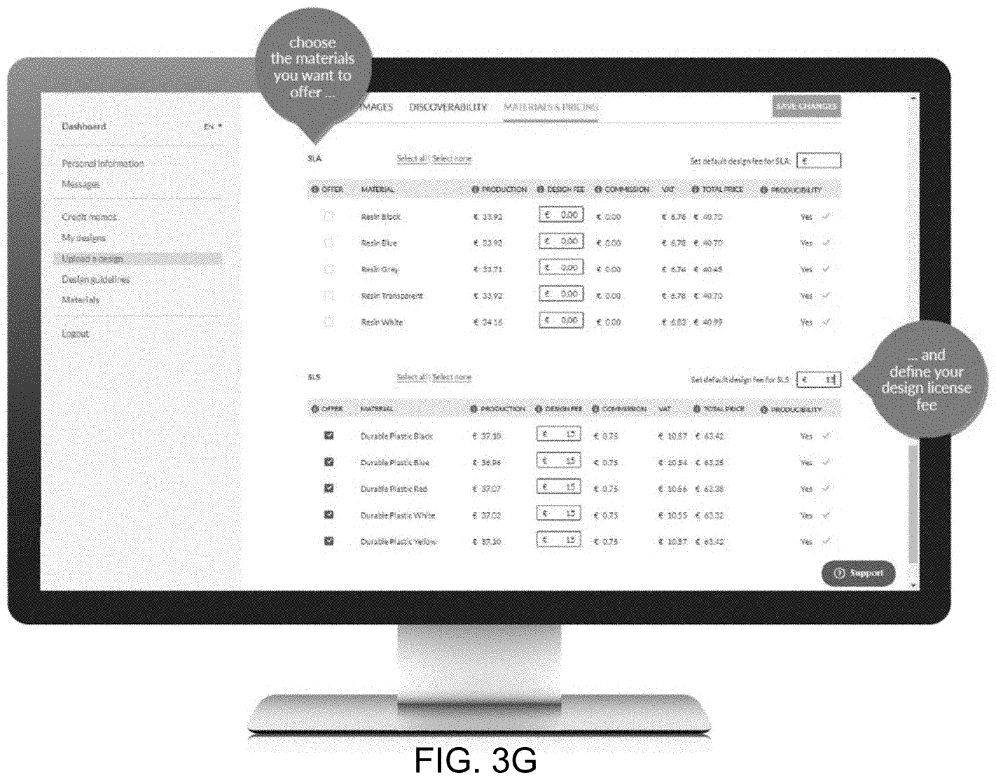

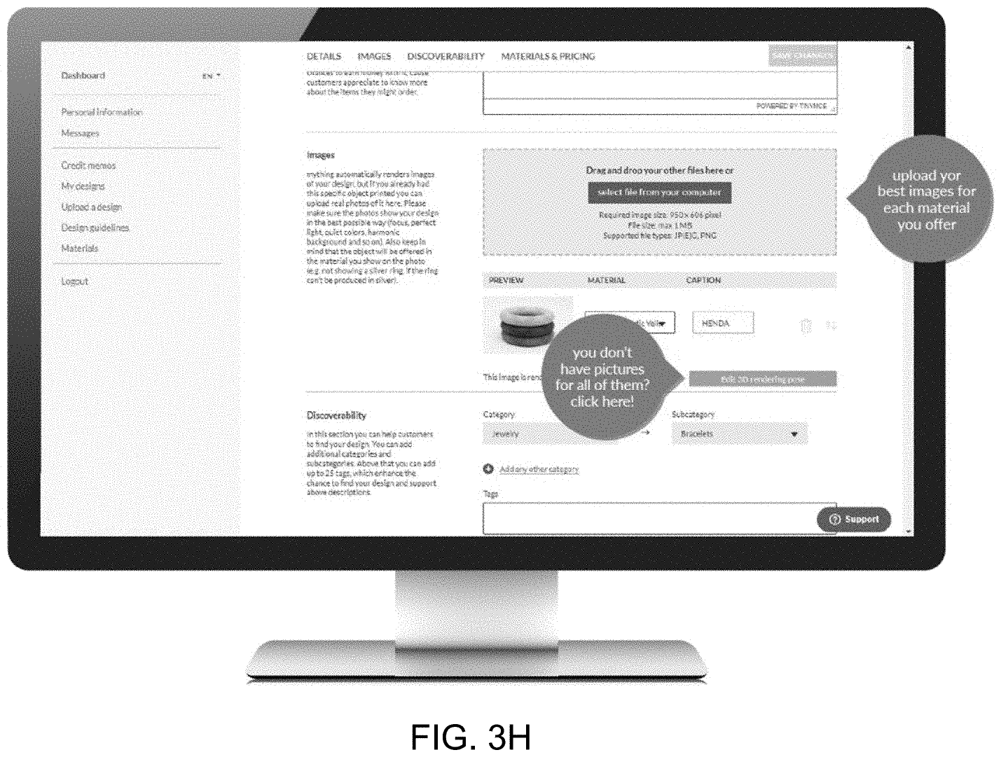

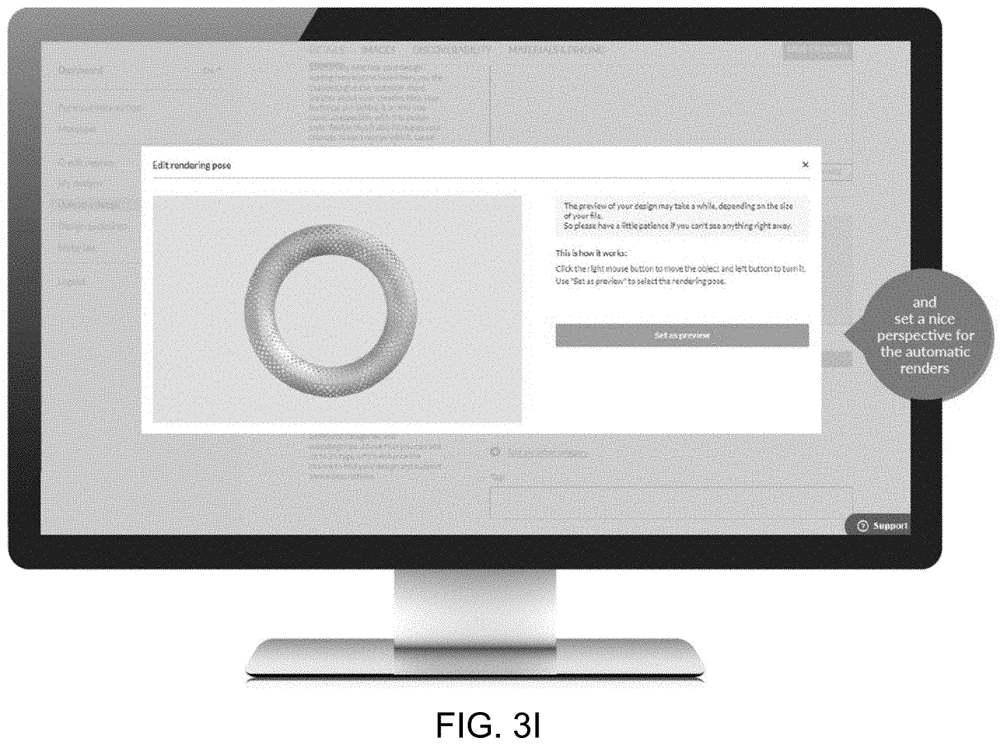

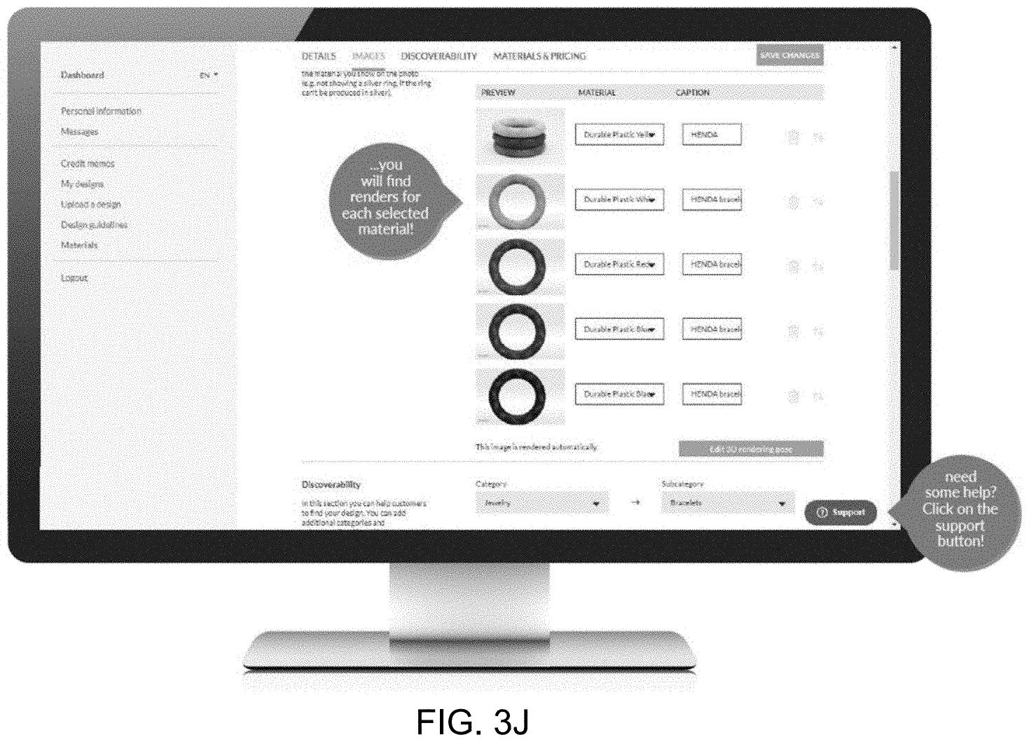

The platform 110 processes 204 the uploaded design. To process the design, the platform 110 can perform a producibility check, verifying whether the design can be produced using a digital manufacturing technique. The platform 110 can also identify parameters for personalizing the design, including any parameters such as material, color, texture, size, or dimensions that can be customized if desired by a customer, as well as any surfaces, elements, or other features of the design that can be customized. Processing an uploaded design is described further with respect to FIGS. 3A-3B.

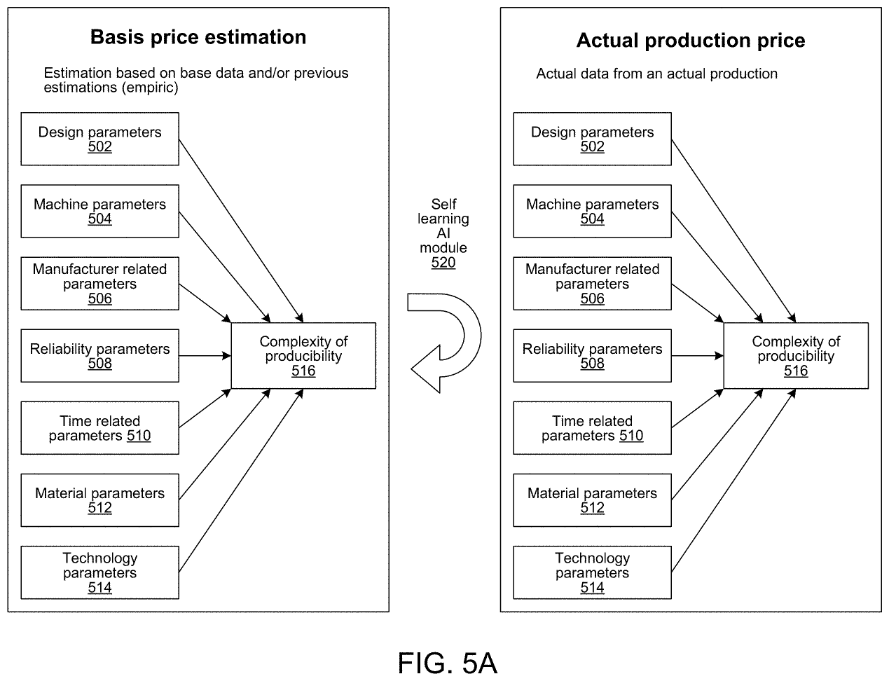

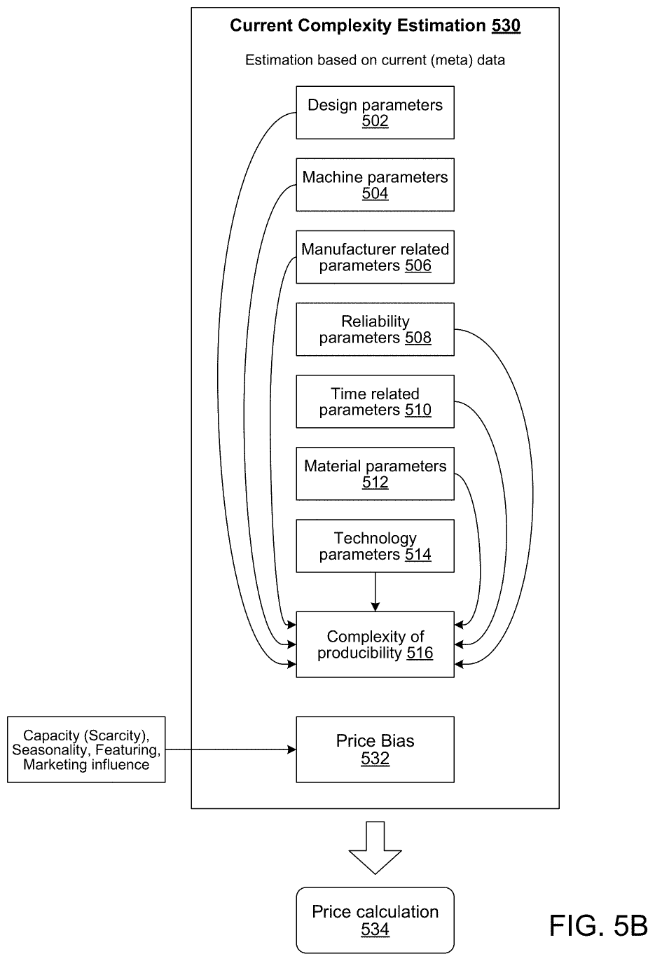

The platform 110 can calculate 206 an estimated price for a product purchased based on the uploaded design. The price can take into account a license fee for the designer, price for materials used to manufacture the product, a fee for the manufacturer, a commission for the digital manufacturing platform 110, and/or shipping and handling costs to ship the finished product to the customer. Price calculation is described further with respect to FIGS. 5A-5B.

In some embodiments, the platform 110 can publish 208 the design to a marketplace storefront maintained by the platform 110. Customers can browse the designs in the marketplace by viewing the storefront on the customer device 140.

If a customer selects a design to purchase, the customer can customize a product before ordering it. The order can include one or more customized product parameters. For example, the customer can select a material or color for the product to be manufactured based on a design. The customer can also specify custom dimensions for the product and components of a design, allowing the customer to feel he or she is generating a new design. For example, if the design is for a mug that is 4 inches tall and has a diameter of 3 inches, the customer can customize the design by ordering the mug to be 5 inches tall. The customer order can further include a preference for whether the product will be shipped to the customer or made available for the customer to pick it up from the manufacturer.

Based on the customer order, the platform 110 calculates 210 a price for the product. The platform 110 also selects 212 at least one manufacturer that is able to fabricate the product given the customizations. The manufacturer can be selected based on a variety of criteria, such as the type of machines 132 operated by the manufacturer, availability of the manufacturer's machines 132, total cost for the product if fabricated by the manufacturer, location of the manufacturer, or other factors. For example, if the product is fabricated by SLA, the platform 110 can identify a set of manufacturers that have SLA machines available within a specified amount of time (e.g., within two business days of the receipt of the customer's order). From the available manufacturers, the platform 110 can recommend a manufacturer who is geographically closest to the customer or a manufacturer who would fabricate the product at the lowest price. In some cases, the platform 110 can recommend a manufacturer to the customer, but give the customer an option to select a different manufacturer. The platform 110 can provide the customer with information about the product price, location of the manufacturer, and/or amount of time for the product to be manufactured for each manufacturer.

The platform 110 can receive 214 an order from the customer once the customer has finalized any customizations and selected shipping preferences or other preferences for the product. Once the order is finalized and a manufacturer has been selected, the platform 110 sends 216 instructions to the manufacturer to produce the ordered product. The instructions can include the design, any pre-processing or post-processing tasks that may be performed on the product, and information for either shipping the product to the customer or notifying the customer that the product is available for pickup.

### Processing Designs

FIGS. 3A-3B are flowcharts illustrating various embodiments of a method for processing uploaded designs. The processes shown in FIGS. 3A-3B can be performed by the digital manufacturing platform 110. The processes are described with respect to FIGS. 3C-3J, which illustrate example user interfaces that can be displayed to a product designer by the product designer device 120 as the designer navigates the upload process.

Referring to FIG. 3A, the platform 110 receives, at step 302, an upload of one or more files with designs for digital fabrication. The platform 110 can allow a designer to upload designs currently supported by the platform 110, as well as versions supported at a later stage through flexible file handling. For example, a designer can upload a file type that contains sufficient instructions to manufacture a design without processing the file further. Alternatively, the designer can upload a file type for a design that can be processed further to enable the design to be manufactured, such as adding instructions for a machine or support filaments. FIG. 3C shows that the designer can upload a design to the platform 110 by, for example, dragging a file into a user interface element or selecting a file stored on the designer device 120. Other methods for uploading a file can be used instead.

The platform 110 checks, at step 304, the uploaded file, such as its file type or format, size of the file, quality of the file, whether the file contains a single part or multiple parts, or other factors.

At step 306, the platform 110 performs a general producibility check to ensure that in general the design can be produced by at least one fabrication method. As mentioned, these fabrication methods include using technologies such as 3D printing, laser cutting, 3D knitting, or CNC milling. The producibility check can verify whether the design complies with laws of physics, such as whether all lines connect and/or whether the walls of the design are thick enough to be manufactured using one at least one of the fabrication technologies. In the general producibility check, the platform 110 can determine whether attributes of the design satisfy a set of producibility requirements. The producibility requirements can include a requirement that walls defined in the design are at least a minimum thickness at every point on the design, where the minimum thickness can be defined, for example, by the minimum thickness that a selected technology is able to produce. For example, if a manufacturer 130 is capable of printing a product with 1 mm walls using a particular 3D printing technology, the platform 110 verifies whether wall thicknesses of the uploaded designs are at least 1 mm even if other technologies have a minimum wall thickness that is greater than 1 mm. Alternatively, the platform 110 can determine whether the uploaded design has a sufficient wall thickness for each of multiple technologies that can be used to fabricate the design.

Other example producibility requirements include whether the model has double faces, whether faces of the model are facing outwards, and whether faces of the model intersect with each other. If the platform 110 determines that the design is producible, the platform 110 can display a verification to the designer, for example as shown in FIG. 3D.

FIG. 3E shows that the designer can preview a rendered version of the design. Optionally, the designer can also use the rendered version of the design to define areas on the design that can be personalized by customers. FIG. 3F shows that the designer can enter information such as a title and description of the design to enable customers to find the design on the platform. Optionally, in the enter product details interface, the designer can also use a dropdown list to switch to provide title and descriptions of the design in another language to improve searchability.

Based on a set of feasible technologies identified by the platform 110, the platform 110 can present the design to the product designer at step 308 to allow the designer to select available properties associated with each feasible technology. FIG. 3G, for example, shows that the designer can select materials and colors to offer to a customer for customization of the design. The materials and colors can be selected from a set of available materials and colors for each technology by which the design can be produced. In some cases, the designer can also identify portions or other parameters of the design that can be personalized by the customer. For example, the designer can identify one or more surfaces of the design that can be fabricated using different textures and adding text and/or image overlays, and can specify textures available for the customer's selection.

After determining feasible parameters for the design and receiving selected parameters from the designer, the platform 110 can perform, at step 310, an in-depth check of the design for multiple possible personalizations of the design. The platform 110 can simulate each of the multiple possible personalizations, verifying whether the design can be produced according to the personalization. Parameters for the personalizations that are simulated by the platform 110 may include fabrication technology, material, color of material, or other parameters that a customer could select. The possible personalizations may be selected automatically by the platform 110 or may be selected by the designer. For example, the designer may indicate particular fabrication technologies that he is or is not interested in being used to manufacture his product. In some cases, the platform 110 can determine whether the design is producible by each possible fabrication technology, in each material available for the technology, and in each color of each material. Any combination of technologies, materials, and colors that are determined to be producible can be presented to the designer, who can select whether to offer the combination to customers as a potential customization.

At step 312, the platform 110 can connect additional assets or data to the design. The additional assets or data can be stored per design, and optionally can be changed at a later versioning stage. An example asset that can be stored with a design is a rendered image of the design displayed from one or more angles and/or in one a range of materials, colors, sizes, or other representational data. Other examples include texts, automatic size determination (e.g., for rings, clothing items, or other wearable products), or associations with other designs or variations of a design. FIG. 3H shows that a designer can upload one or more images of the design. The images can include photographs of the fabricated design, renders of the design, or other images that the designer selects to represent the design. The designer can add additional information, such as category labels or a description to help customers find the design in the marketplace. As shown in FIG. 3I, the designer can preview a render of the design generated by the platform 110. The designer can interact with the preview shown in FIG. 3I, moving the design around or rotating the design to different angles, to select an appearance of the rendered design that will be displayed to customers in the marketplace. FIG. 3J shows that the platform 110 can render the design in all available materials and colors, which can be displayed in the marketplace to allow customers to view a customized product.

The platform 110 can perform a maximum producibility check on the design at step 314. The maximum producibility represents a range from a minimum size to a maximum size of a product customized based on the design, ensuring that any customized variant chosen by a customer can be produced. The minimum and maximum size can be defined, for example, by a minimum or maximum size of a specified dimension of the design, with other dimensions scaled according to the specified dimension. Alternatively, the minimum and maximum size can be defined as a minimum or maximum of each dimension in the design, or parametric relationships defining a minimum or maximum for a first dimension given a minimum or maximum for a second dimension in the design. Any of a variety of criteria can be used by the platform 110 to determine the maximum producibility range, such as minimum wall thickness, overhangs, additional support structures, detail sizes, hole sizes, connection thicknesses, sharpness of edges, and sizes of the machines 132. In some embodiments, the platform 110 uses an artificial intelligence model and heuristics to determine minimum and maximum product dimensions that satisfy the criteria. The level of complexity in the overall production process, as well as pre- and post-processing steps, is estimated based on previous steps shown in FIG. 3A and other design- and technology-related data points.

At step 316, the platform 110 can perform an on-demand manual check for edge cases to verify that the edge cases are producible. For example, the AI module can identify edge cases such as the minimum and maximum dimensions where the platform 110 should repeat a producibility check, ensuring that the design is producible at the edge cases.

The platform 110 can set a license fee for the design at step 318. The license fee, or compensation paid to the designer if a customer orders the design, can be selected by the designer. FIG. 3G illustrates an example of the designer setting a design license fee of €15. The designer can set the same license fee for all variations of his or her design, or different license fees for different fabrication technologies, colors, materials, sizes, or other customizable parameters of a design. As also illustrated in FIG. 3G, the platform 110 can show the designer an estimated total price for the product based on the designer's selected fee, optionally breaking the total price down to its component parts (product costs, license fee, platform commission, and any associated taxes), to allow the designer to adjust the license fee to achieve a particular estimated price. In some embodiments, the platform 110 can also display a recommended license fee, calculated for example based on the license fee charged by designers of similarly sized or similarly complex designs.

The platform 110 can then estimate a price for the product at step 320, given design parameters that may be selected by a customer. In some embodiments, the price calculation can be assisted by an AI module that receives information about actual price of other products and calculates, for a variety of selected design parameters, an expected price based on the actual prices of the other products. The price calculation can take into account possible and probable customization outcomes that change, for example, the size or weight of the product or difficulty of fabricating the product. As illustrated in FIG. 3G, in one embodiment, the platform will show variations in production cost depending on the customizations made, such as selecting different materials or colors.

The platform 110 can perform a design content check using an AI module at step 322. The design content check can determine whether the design violates an existing license on the platform, such as checking for duplicate designs and design variations previously uploaded to the platform 110. Alternatively, the design check can verify whether the design complies with a policy of the platform 110, determining, for example, if the design includes illegal content or unwanted content such as violent or racist text.

If possible content or license violations are detected, the platform 110 can perform a manual check at step 324. For example, the platform 110 can flag the design for review by a human reviewer, who can mark the design as acceptable or identify a particular policy violated by the design. The results of the manual check can be fed back into the AI module to improve the module's accuracy. A design that is determined to violate a content license or policy can, in some cases, be modified to comply with the rules. These changes may include, for example, adapting content of the design, making overall changes to meet an expected quality of the design, or generally optimizing the design to achieve a specified price or producibility. In some cases, the platform 110 may automatically modify the design. In other cases, the platform 110 may require the designer to modify the design, or may push the design to an in-house designer to make any modifications necessary to comply with licenses or policies.

Once the design has passed the producibility and content checks, the design can be published by the platform 110 at step 326, making the design available for purchase by a customer.

FIG. 3B shows a variation of the design upload process shown in FIG. 3A, including steps that are similar to the process in FIG. 3A. A discussion of the steps also appearing in FIG. 3A is omitted here. In the embodiment shown in FIG. 3B, if the design is determined to not be producible, the platform 110 can repair the design to make the design producible. At step 328 in FIG. 3B, the platform 110 performs a general producibility repair on the design if the design is found to not be producible by one or more fabrication technologies at step 306. The repair process can, for example, connect any lines in the design that are disconnected and increase wall thicknesses until all walls are at least a threshold thickness. The platform 110 can apply one or more predetermined policies when repairing a design. For example, when connecting two disconnected lines, the platform 110 can connect the lines by adding a connector across the shortest distance between the disconnected lines. As another example, when increasing wall thickness, the platform 110 can increase the thickness of all walls in the design proportionately or by the same amount until all walls are equal to or greater than the threshold thickness. Alternatively, the platform 110 may only increase the thickness of the wall that is thinner than the threshold, without changing the thickness of any wall that is thicker than the threshold.

Referring further to FIG. 3B, the platform 110 can render and display a design to the designer in relation to other objects at step 330, giving the designer a scale for the size and appearance of the product when produced based on the design. For example, a measuring system in the applied metrics can be shown and the rendered design can be displayed in relation to common reference items (e.g., common household items) to allow the designer to compare the design size to the reference items. The designer can then alter the design's size if desired. A producibility check can be repeated at step 332 if the designer makes any changes to the size of the design. At step 334, the platform 110 can repeat steps 330 and 332 for other files the designer uploaded or for variants on a file, for example rendering the same design in different materials selected by the designer.

The platform 110 can check each variant of a design at step 336 to ensure that it complies with producibility requirements. The variants of a design selected by the designer can be associated with one another at step 338.

Manufacturer Registration

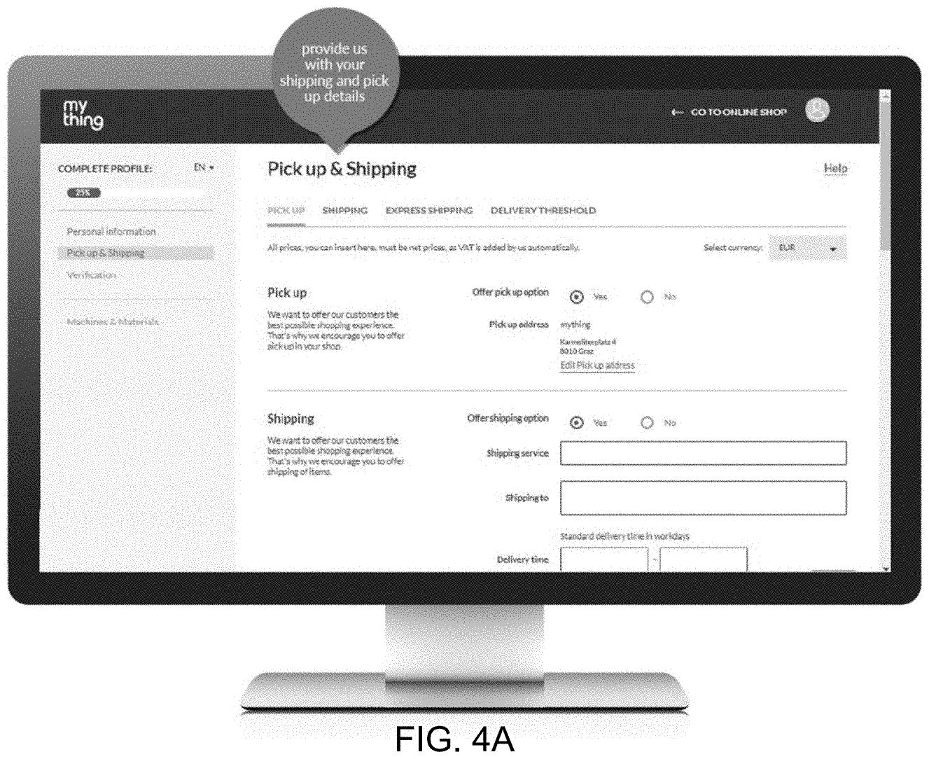

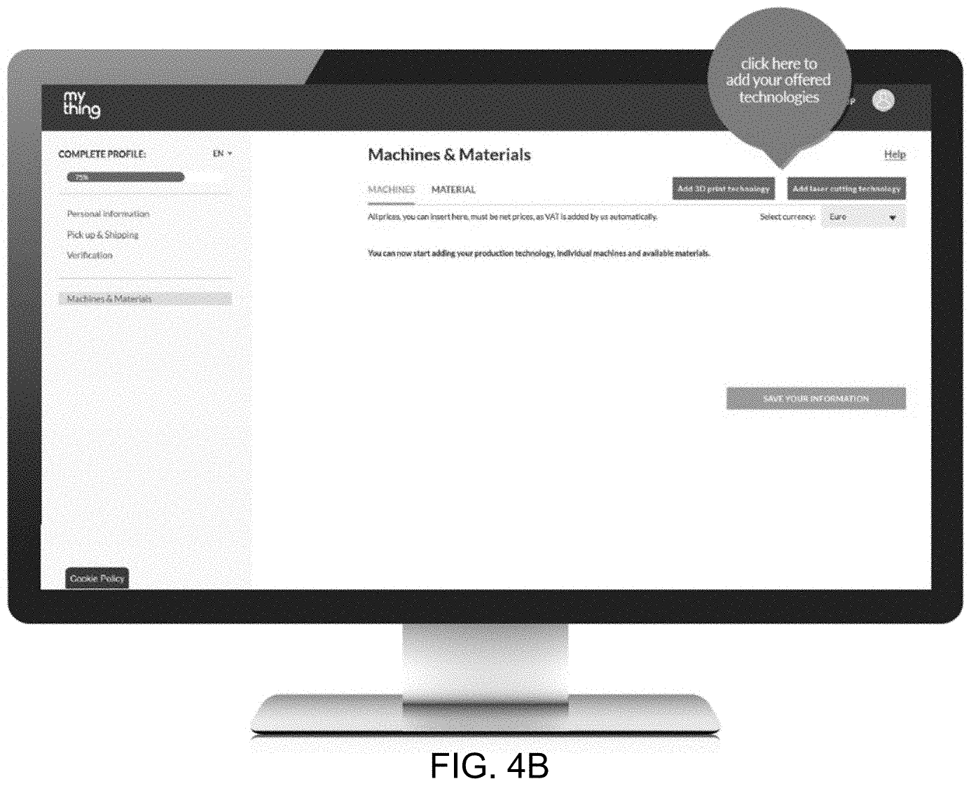

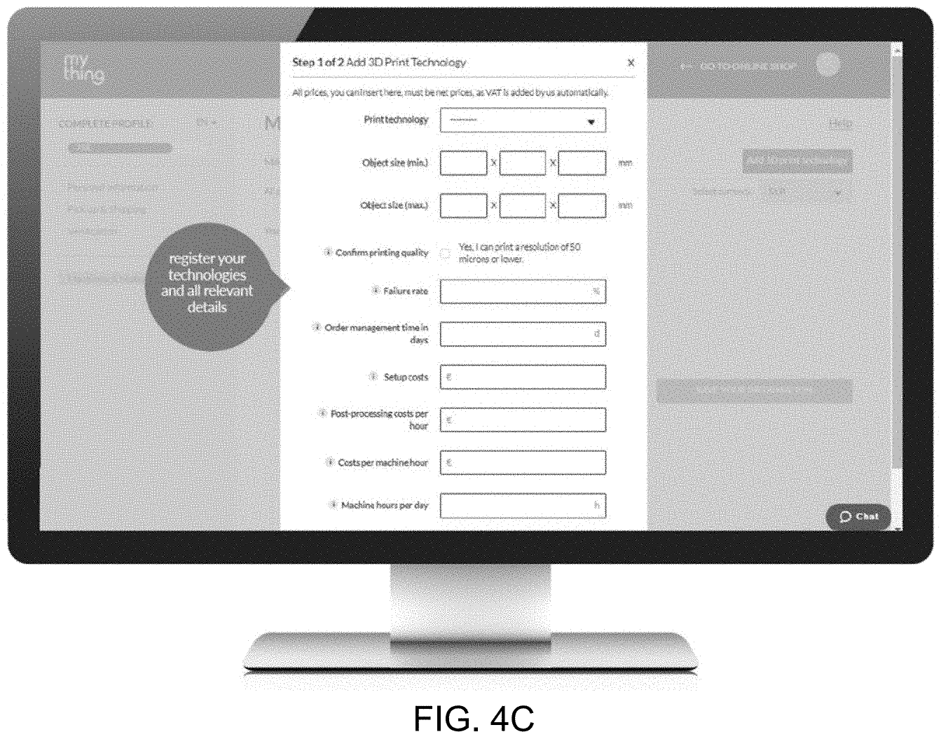

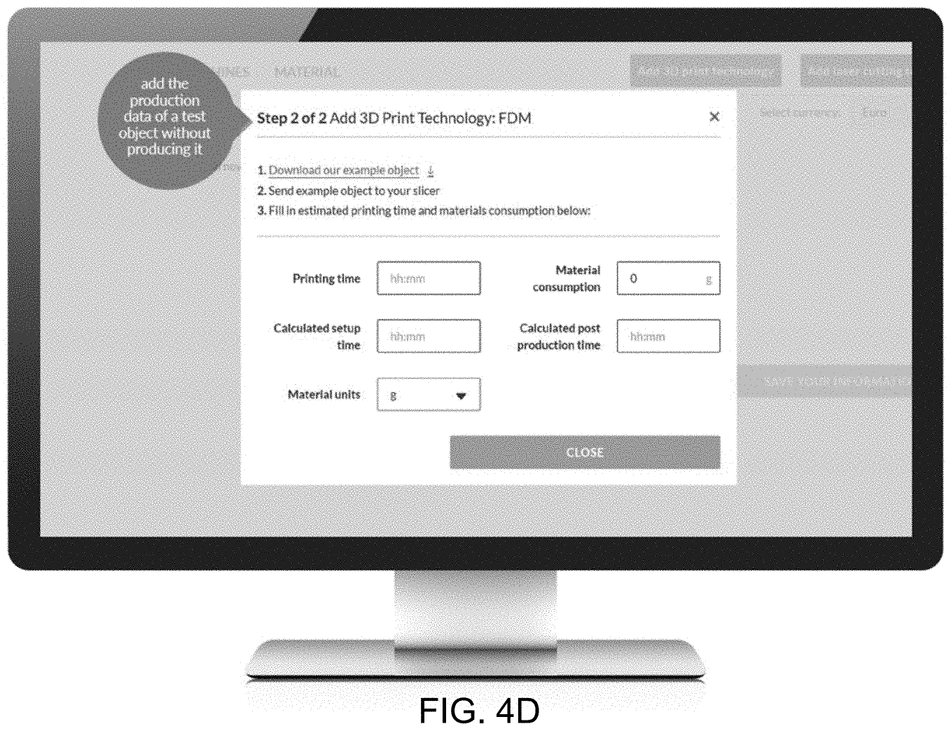

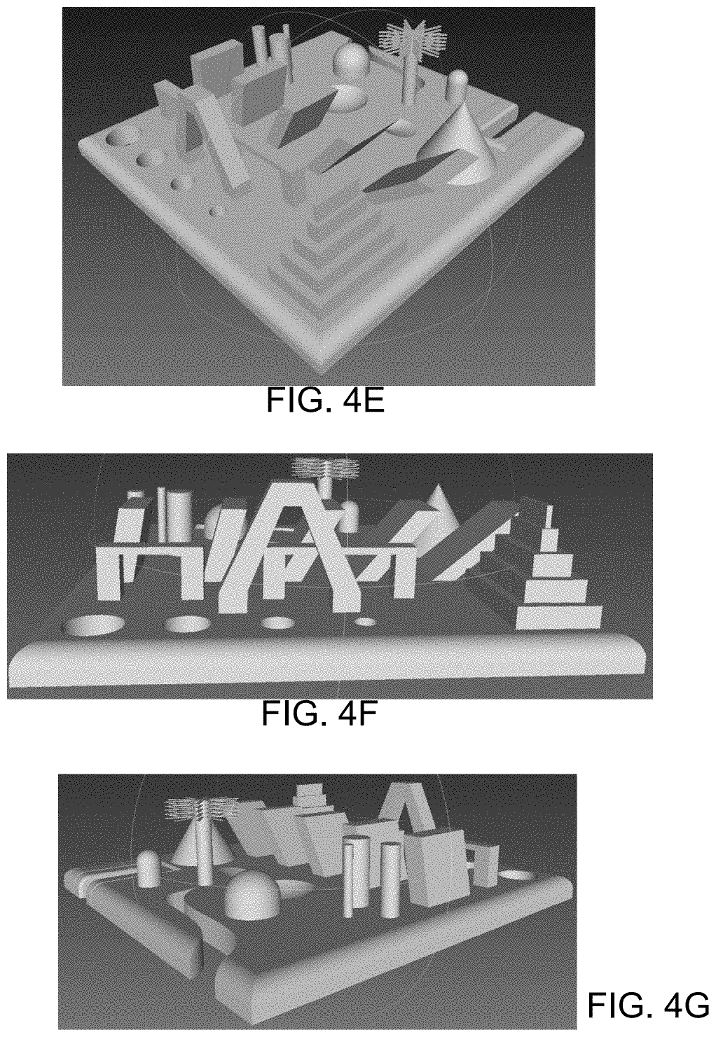

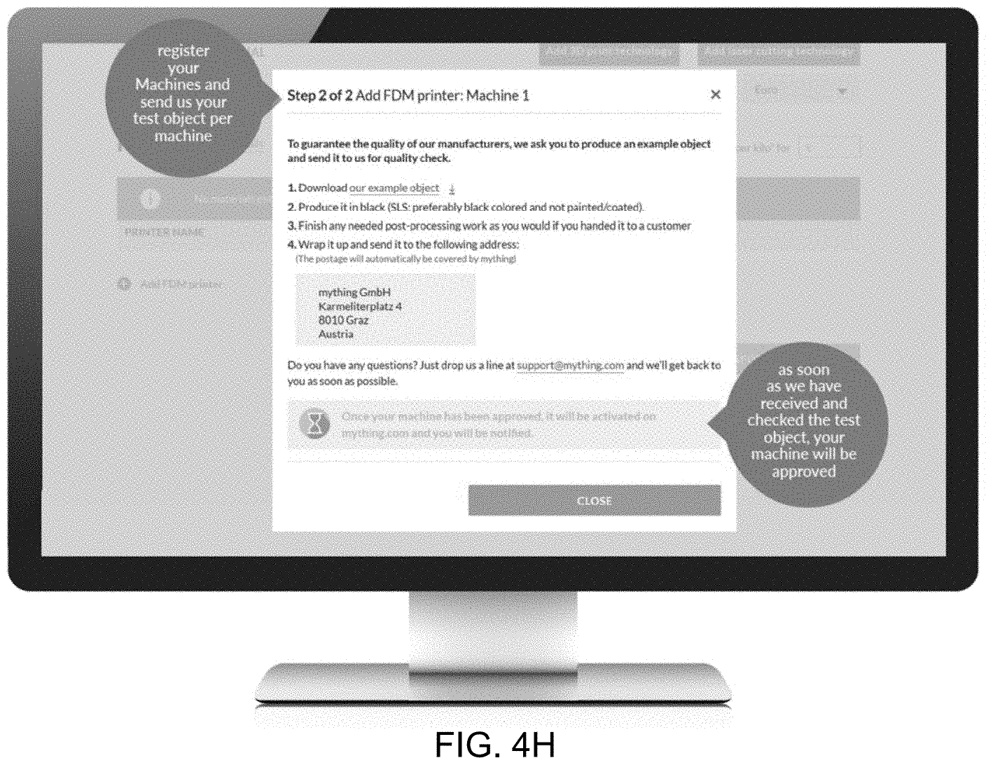

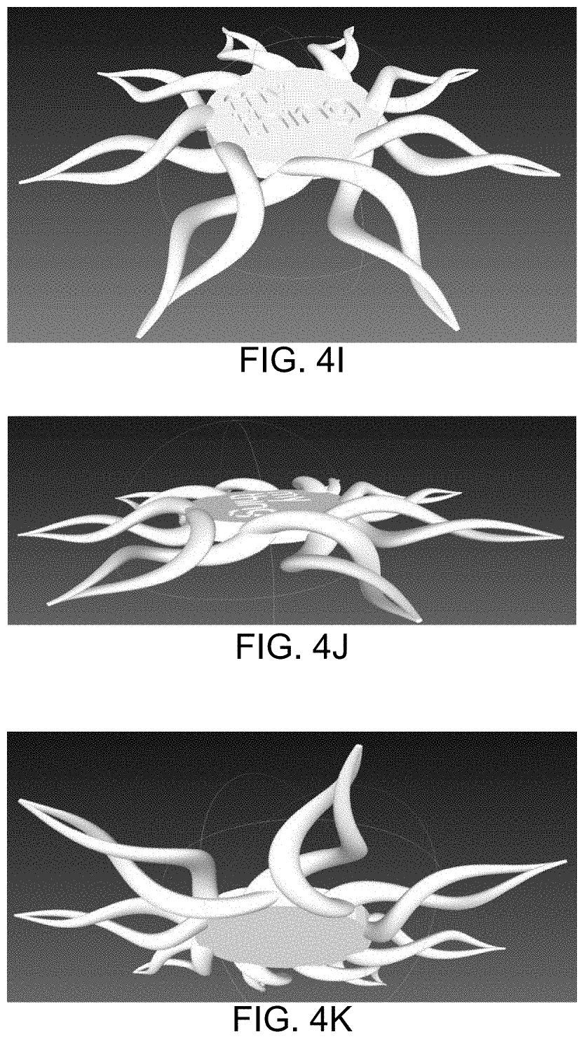

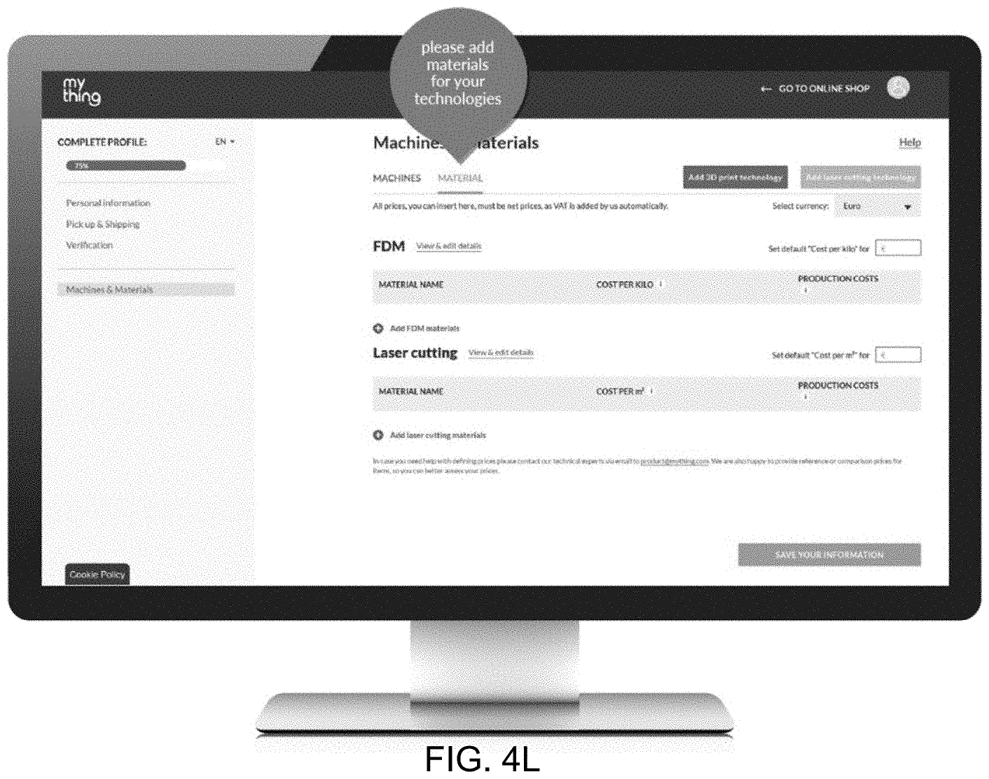

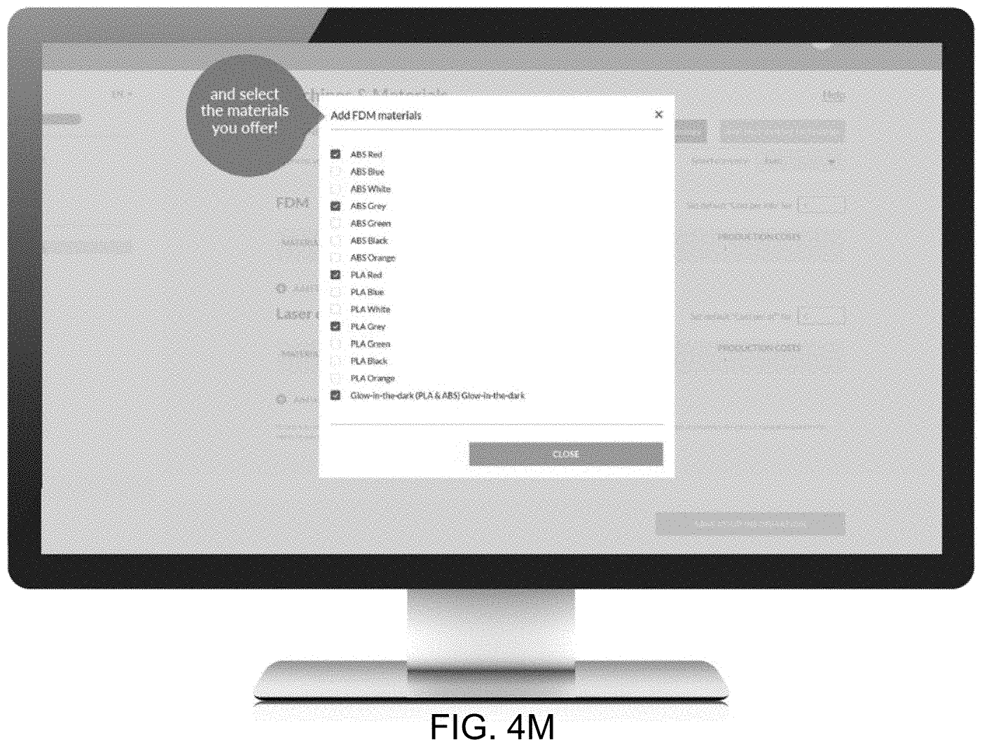

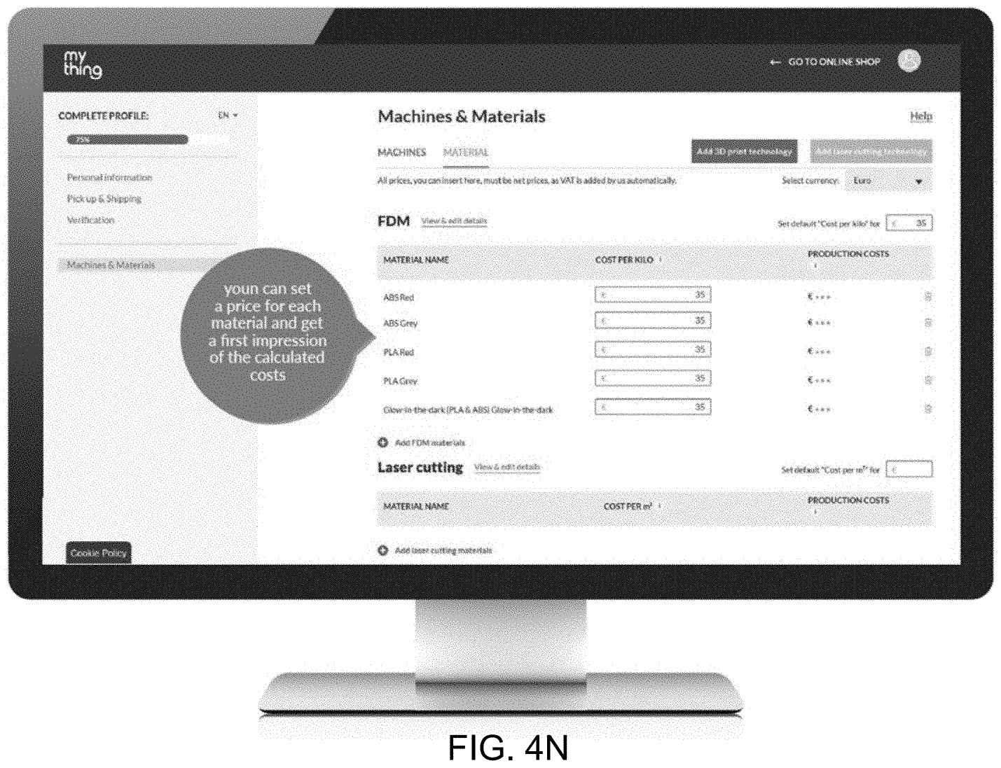

FIGS. 4A-4N illustrate a process used by a manufacturer to register with the digital manufacturing platform 110 as a provider of manufacturing services. The user interfaces shown in FIGS. 4A-4N can be displayed to an administrator of the manufacturer by the manufacturer system 130.

After creating an account with the platform 110, FIG. 4A shows that the manufacturer can specify whether they would prefer to ship finished products to customers, allow the customers to pick up the products, or both.

As shown in FIG. 4B, the manufacturer can register one or more 3D printing or laser cutting machines 132 to the platform 110. FIG. 4C illustrates an example form the manufacturer can fill out to register a 3D printer to the platform 110. As shown in FIG. 4C, the manufacturer provides information about manufacturing capabilities of the machine, such as the 3D printing technology used by the machine (e.g., SLS, SLA, MJF, or FDM), minimum and maximum object sizes the machine can print, feature resolution, or failure rate of the machine. The manufacturer can also specify an amount of time in days needed to complete an order, setup costs, post-processing costs, and costs per machine hour. Furthermore, the manufacturer can specify an amount of time each day and/or the number of days per week the machine is available to print designs from the platform 110. For example, the manufacturer may be willing to use the machine for four hours each day to print designs ordered through the platform 110.

FIG. 4D illustrates that the manufacturer can be required to print an example object from the platform 110 to demonstrate that the manufacturer is able to meet specified 3D printing parameters in a high complexity design. After printing the example object, the administrator or the manufacturer provides information about printing time, amount of materials consumed by the print, setup time, and post-production time. Based on the information provided by the administrator or the manufacturer, the platform 110 can calibrate expected material costs and printing time for the machine. FIGS. 4E-4G illustrate various views of a possible example object.

The platform 110 can also request a test object from the manufacturer. FIG. 4H shows that the platform 110 can provide the manufacturer with a test object to print and mail to an administrator of the platform for review and approval. FIGS. 4I-4K illustrate views of an example test object. The test object can be used, for example, to verify that the printer is capable of producing a design with sufficient quality, of a certain resolution, or satisfying other criteria. In some cases, the platform 110 may send a manufacturer a unique design to be printed on each machine registered by the manufacturer, allowing the platform 110 to verify that a test object was printed by a particular machine.

Once a manufacturer has added any desired machines, the manufacturer can provide information about the materials the manufacturer has available for use. FIG. 4L shows that the manufacturer can, for example, select the materials available for its FDM printers. The manufacturer could also set different prices for a material based on the type of fabrication technology used (such as using laser cutting instead of FDM). FIG. 4M shows a few exemplary materials and colors that that are available to the manufacturer for fabrication using the FDM printer(s). FIG. 4N shows that the manufacturer can provide information about the cost per unit (e.g., cost per kilogram) of each available material. In some cases, the platform 110 can show the manufacturer information about the prices charged by other manufacturers. For example, the platform 110 can display information showing that the average cost per kilo of PLA red is €35, allowing the manufacturer to decide whether to charge the same amount, more, or less than the average cost for each material and color combination. The platform 110 can display statistically calculated reference prices for the materials based on the prices charged by all manufacturers on the platform or a subset of the manufacturers on the platform (e.g., all manufacturers within a particular country), reference production costs based on reference designs, or based on other reference values.

### Calculating Price for Customized Products

When a customer customizes a product on the digital manufacturing platform 110, the platform 110 calculates a price for the product. FIGS. 5A-5B illustrate example factors used by the platform 110 to calculate the price.

As shown in FIG. 5A, the platform 110 can perform a basic estimation of a product's complexity 516 using one or more of design parameters 502 (such as overall size, number of features in the design, or size or tolerance of features in the design), machine parameters 504, manufacturer-related parameters 506, reliability parameters 508, time-related parameters 510, material parameters 512, or technology parameters 514. The platform 110 can also receive one or more of these parameters for actual fabricated products. The actual parameters can be fed into a self-learning AI pricing module 520 that improves the basic complexity estimation over time. For example, the AI pricing module 520 uses past prices charged by manufacturers to learn, over time, to calculate an amount of material that will be used to manufacture a product with more precision. This improved precision improves the ability of the platform 110 to predict the material amount that will be required for a given design, which in turn improves the accuracy with which the platform 110 can predict how much a manufacturer will charge the platform to fabricate a product. As another example, the AI module 520 learns over time to predict the reliability of machines more accurately by analyzing information about the machines' past reliability as they fabricated products.

FIG. 5B shows that the platform 110 can use a complexity estimation 530 to calculate a price 534 for a product. The platform 110 can calculate the price by applying a price bias 532 to the complexity 516 (calculated, for example, using one or more of design parameters 502, machine parameters 504, manufacturer-related parameters 506, reliability parameters 508, time-related parameters 510, material parameters 512, or technology parameters 514). The price bias can be determined based on factors such as manufacturing capacity (e.g., the number of available machines using a particular fabrication technology relative to the demand for products produced by that technology), seasonality (e.g., trends in product demand, such as around holidays), featuring (e.g., whether a premium should be applied to a featured product), or marketing influence (e.g., whether the platform or a designer has reduced the price of a product to attract customer demand). In some embodiments, the price bias can be calculated using a price bias model that is trained to predict manufacturer capability and product demand based on historic product orders placed by customers. In some embodiments, the platform 110 calculates the price bias using a combination of heuristics (e.g., fixed limits on manufacturing capacity of machines or specified dates where certain categories of products may be more or less in demand), manual information entered by designers or manufacturers (such as a manufacturer's promotional discount), and/or a trained model that takes into account historical ordering patterns. The price bias calculated by the platform 110 may be a value that is added to or subtracted from the basic price, such as $5, to calculate an order price for the product. Alternatively, the price bias may be a value that is multiplied by the basic price (e.g., 1.2 or 0.93) to calculate the order price.

### Completing a Product Order

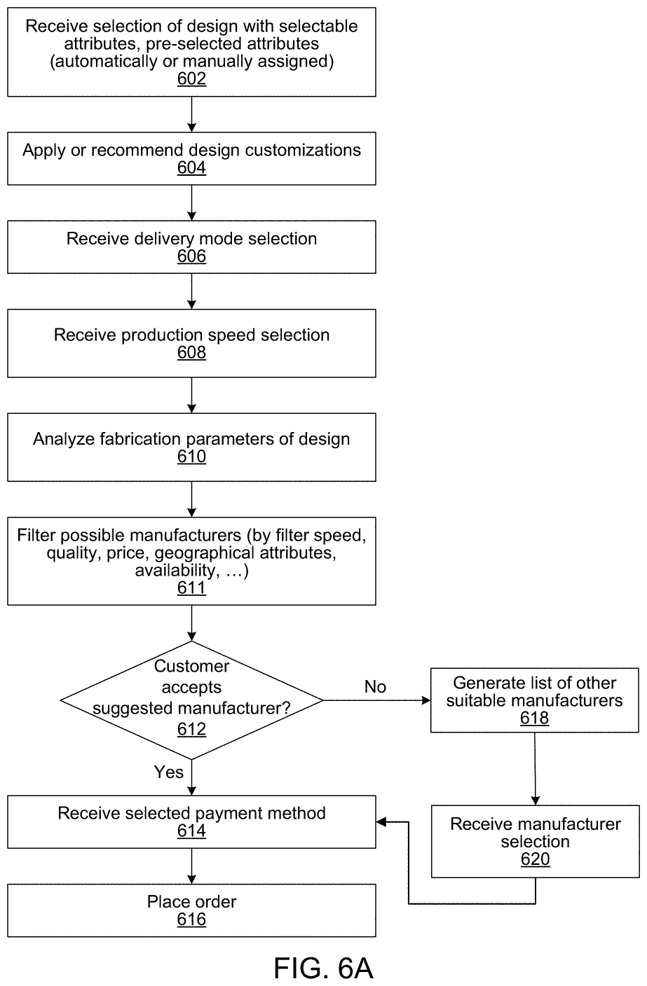

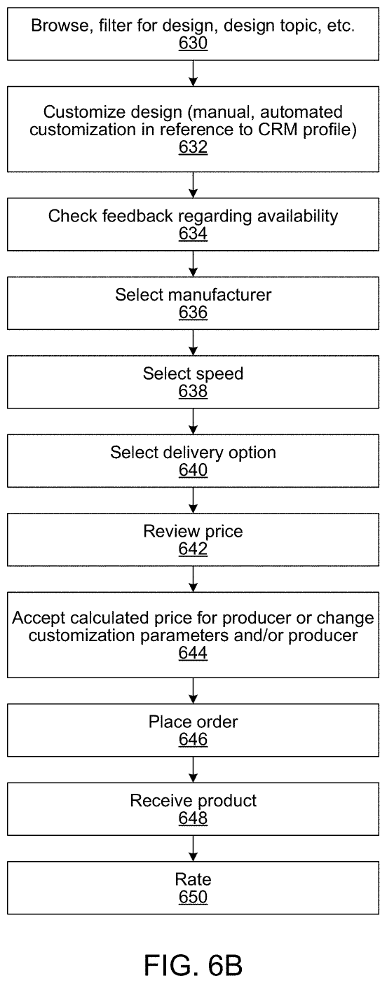

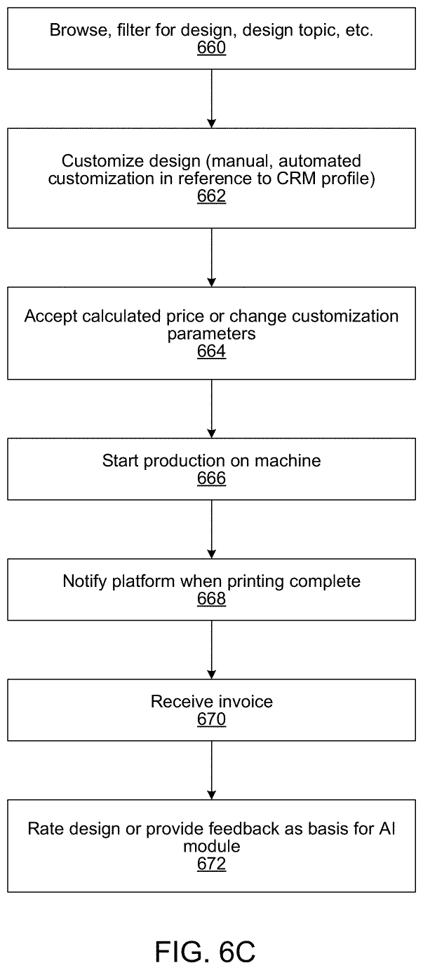

FIG. 6A is a flowchart illustrating an example process for receiving a product order from a customer. The process shown in FIG. 6A can be executed by the platform 110, in response to the customer's interactions with a browsable marketplace of digital designs.

As shown in FIG. 6A, the customer can select a design to order, and the platform 110 can receive the customer's selection at step 602. The customer may have several options for selecting a design, including uploading a custom design to the platform 110, choosing a design from the platform 110 with pre-selected attributes, choosing a design from the platform 110 and customizing its attributes, or choosing a design from the platform 110 and having the platform 110 customize the attributes based on the customer's profile information, such as information available to a customer relationship management system (CRM).

If the customer is selecting from among designs that were uploaded to the platform 110, the platform 110 can facilitate a process for searching the designs. In some cases, the platform 110 can categorize the designs based on tags added by the designers or automated tagging performed by the platform 110. In some cases, the customer can search the platform marketplace by the title of designs using a faceted search, which for example enables the customer to filter by fabrication technology or color or material choices. The platform 110 can sort search query results based on marketing campaigns, based on predictions of designs that the customer is likely to be interested in, or based on other factors. Additionally or alternatively, the platform 110 can facilitate image-based search. For example, if a customer uploads an image of a product to the platform 110, the platform can search the designs on the platform to identify any designs that are similar to the product in the image.

In some embodiments, the platform 110 can automatically apply or recommend design customizations to a customer at step 604. For example, if other customers who have ordered a particular design often applied a particular customization to the design (e.g., changing a dimension of the design), the platform 110 can recommend that the customer apply the same customization. Alternatively, if a customer has often applied a particular customization to other designs the customer has ordered (e.g., buying wearable rings that are a particular size), the platform 110 can recommend the same customization when the customer selects a new design to purchase.

If the customer makes any customization selections, the platform 110 can generate a modified version of the digital design that includes instructions readable by a machine 132 to fabricate the product as customized by the user. For example, if the customer requests a product in a larger size, the platform 110 generates a modified digital design by scaling the original digital design up to the size requested by the customer.

For any design selected by the customer, the platform 110 can receive the customer's selection of a delivery mode at step 606. The delivery mode can be an indication of whether the customer would prefer to pick up the product or have the product shipped. The delivery mode can also include an amount of time until the arrival of the product, such as an election of expedited shipping.

The customer can also select a production speed for the product, which is received by the platform 110 at step 608. Production speed can be chosen, for example, between a normal speed and an expedited speed, where expedited is a higher fee than the normal speed.

At step 610, the platform 110 analyzes the digital design ordered by the customer to determine fabrication parameters for the design. The fabrication parameters can include any parameters of the product that is to be produced. For example, the fabrication parameters may include a minimum feature size in the product, a maximum dimension of the product, the smallest wall thickness in the product, an estimate of a volume of material that will be used to manufacture the product, or information about support structures that will be generated while the product is fabricated based on the digital design. The fabrication parameters may be determined before the digital design is published to the marketplace. However, if the customer customizes the product in any way, the fabrication parameters may change based on the customizations. Thus, platform 110 may analyze the modified digital design file generated based on any customization selections by the customer to determine the actual parameters of the product that will be fabricated.

Based on the design and its customizations ordered by the customer, as well as the customer's delivery mode and production speed preference, the platform 110 filters manufacturers at step 611 to identify a set of possible manufacturers. The possible manufacturers in the set can be selected based at least in part on a determined match between the fabrication parameters for the product and specifications of one or more machines associated with the manufacturers. For example, if a fabrication parameter specifies the smallest feature size in the product that will be produced, the platform 110 filters manufacturers to find a machine that can produce features that are at least as small as the smallest feature in the design. Similarly, if a fabrication parameter specifies a maximum dimension of the product (such as a maximum height and/or width), the platform 110 filters manufacturers to find a machine that can fabricate products at least as large as the maximum dimension.

The possible manufacturers can also be selected at step 611 based on the customer's delivery and timing preferences. For example, if the customer requested pickup of the completed product, the platform 110 can identify any manufacturers within a threshold distance of the customer's geographic location (e.g., 25 miles) that have machines capable of producing the product (accounting for fabrication technology, size, and complexity of the product), whose capable machines are available within a time frame corresponding to the customer's production speed preference. The platform 110 can select a recommended manufacturer from the set of available manufacturers, for example selecting a manufacturer that is closest to the customer's location or that is able to fabricate the product for the lowest price. The platform 110 may use other criteria to select manufacturers, for example selecting a manufacturer based on a load balancing analysis of designs previously sent to a set of candidate manufacturers.

If at step 612 the customer accepts the manufacturer recommended by the platform 110, the customer can proceed to select a payment method (received by the platform at step 614) and place an order (at step 616).

If the customer does not accept the recommended manufacturer, the platform 110 at step 618 can generate a list of other possible manufacturers selected from the identified set. In some embodiments, the platform 110 can rank the manufacturers in the generate list based on properties such as proximity to the customer, price, or production speed. The list can be displayed to the customer, and the customer can select a desired manufacturer from the list. The platform 110 receives the customer's selection at step 620. The customer can then proceed to entering a payment method and placing an order.

FIG. 6B is a flowchart illustrating an example process by which a customer may complete a product order, according to one embodiment. The user can use the customer device 140 to complete the process shown in FIG. 6B. As shown in FIG. 6B, the customer can browse designs in the platform marketplace at step 630, filtering for example by design title or category. The customer can customize the design at step 632, manually selecting parameters or using parameters recommended by the platform 110. The platform 110 can check availability of the design (e.g., to determine whether the designer removed the design from the marketplace) and provide feedback regarding the product's availability to the customer, which the customer reviews at step 634. The customer can select a manufacturer (at step 636), production speed (at step 638), and delivery option (at step 640). The customer can then, at step 642, review a price calculated based on the design, design customizations, manufacturer, production speed, and delivery preference. If desired, the customer can change the selections to change the price at step 644; otherwise, the customer can place the order at step 646. Once the order has been placed, the customer can receive the product at step 648. Depending on the delivery method selected, the customer may receive the product when it is delivered to the customer or by picking up the product from the manufacturer. After the customer receives the product, the customer can rate the product and/or the manufacturer at step 650.

FIG. 6C is a flowchart illustrating another example process for a customer to complete a product order. In the example of FIG. 6C, the customer orders a design to print on his or her own 3D printer, rather than sending the design to a third-party manufacturer. A similar process can be used if the customer is manufacturing a product using digital fabrication technologies other than 3D printing. As shown in FIG. 6C, the customer can browse designs in the platform marketplace at step 660, filtering for example by design title or category. The customer can customize the design at step 662, manually selecting parameters or using parameters recommended by the platform 110. The platform 110 can calculate a price for the design based on the customization selections. At step 664, the customer can either accept the calculated price or change the customization selections to change the price. The customer can then receive the design from the platform 110 and, at step 666, fabricate the product based on the design using the customer's 3D printing machine. At step 668, the customer notifies the platform 110 when the product has printed, triggering the platform 110 to create an invoice. The customer receives the invoice from the platform 110 at step 670. The customer can also rate the design, provide feedback about time and materials used by his machine to manufacture the product, or provide other information for the platform 110 to use to train one or more AI modules at step 672.

### Adding Production Technologies and Machines

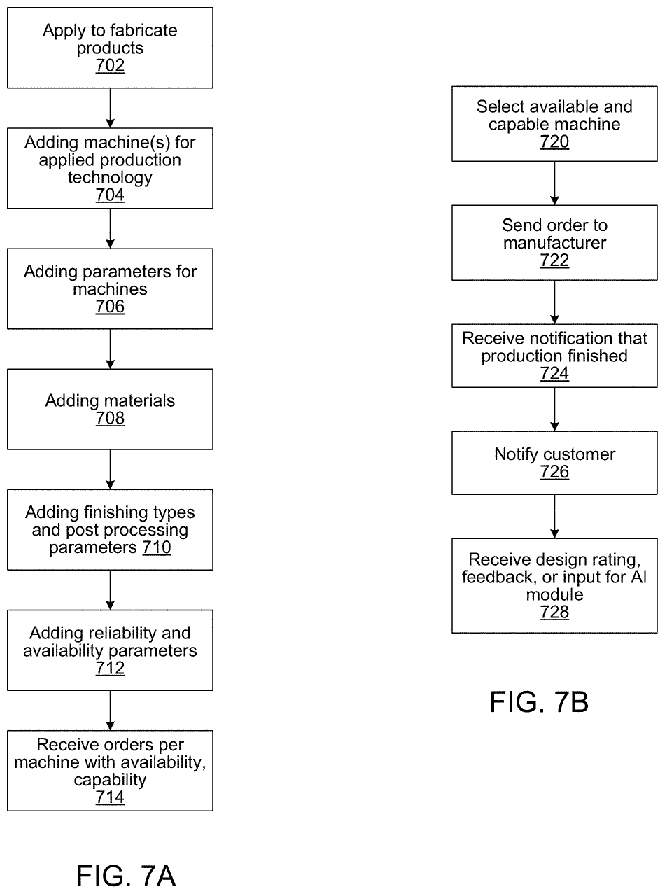

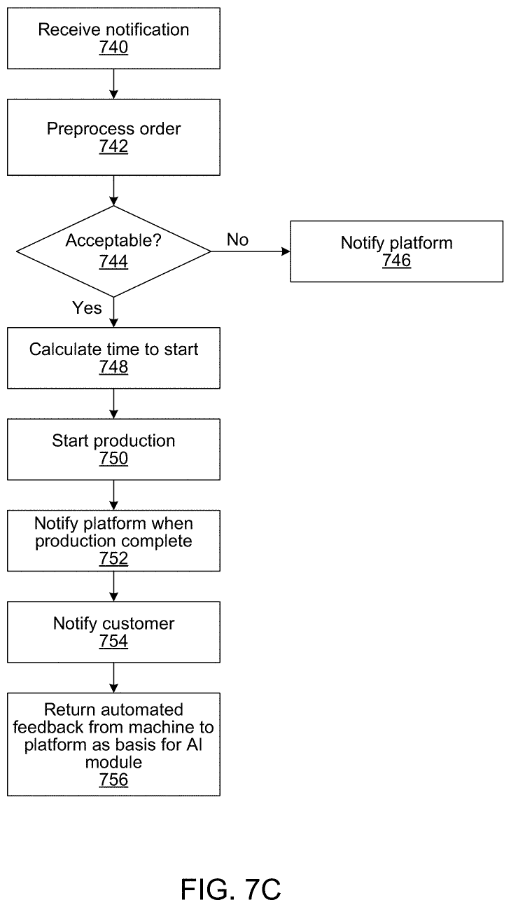

FIG. 7A is a flowchart illustrating an example method for registering a machine to the manufacturing platform 110. The process shown in FIG. 7A can be performed by an administrator of a manufacturer system 130 (referred to herein as a manufacturer).

As shown in FIG. 7A, the manufacturer can apply at step 702 to fabricate products using one or more fabrication technologies. When applying, the manufacturer can create a profile with the digital manufacturing platform 110. The manufacturer can add one or more machines to the manufacturer's profile with the digital manufacturing platform 110 at step 704, and can specify parameters of each machine (e.g., maximum and minimum size, resolution, etc.) at step 706. In some cases, the manufacturer can print one or more test objects received from the platform 110. The test objects can be used to evaluate parameters of a machine. For example, the manufacturing platform 110 may verify that the parameters entered for a machine are correct by evaluating the test object printed by the machine. The manufacturer can also add information to the profile about materials the manufacturer has available (at step 708) and any post processing techniques or finishing types the manufacturer is able to perform (at step 710). Finally, at step 712, the manufacturer can provide information about the reliability and availability of each machine, including the failure rate of the machine, number of hours per day and days per week the machine is available to print products from the platform 110. Once the manufacturer's profile is complete, the manufacturer can begin to receive orders, at step 714, for one or more of its machines that match the machine's availability and capabilities.

### Fulfilling a Product Order

FIG. 7B is a flowchart illustrating an example process for fulfilling a product order. The process shown in FIG. 7B can be performed by the digital manufacturing platform 110. As shown in FIG. 7B, after receiving a product order from a customer, the platform 110 can check availability and capabilities of manufacturers and select, at step 720, a machine that is both available on the customer's requested timeline and capable of manufacturing the product, based on parameters of the digital design file corresponding to the product. At step 722, the platform 110 can send the order to the manufacturer associated with the selected machine. The manufacturer can receive a notification of the order and fabricate the product on the selected machine. In some cases, if the manufacturer has several machines that are capable of fabricating the product (e.g., multiple identical machines, or different machines whose capabilities match the parameters of the design), the platform 110 may send the order to the manufacturer and permit the manufacturer to choose between the capable machines.

Once production is finished, the platform 110 can receive a notification from the manufacturer at step 724. At step 726, the platform 110 can notify the customer either that the product is ready for pickup or is being shipped to the customer, depending on the customer's delivery preferences. Alternatively, the manufacturer can directly notify the customer and either allow the customer to pick up the product or ship the product to the customer. The manufacturer can also provide information about the fabrication process to the platform 110, such as rating the design, updating actual time or materials used to fabricate the design, or providing other feedback, which the platform 110 receives at step 728. The platform 110 can use the feedback to improve future designs or cost calculations, for example if the machine used a different amount of material than predicted.

FIG. 7C is a flowchart illustrating an example process for fulfilling a product order. The process shown in FIG. 7C can be performed by a manufacturing system 130.

As shown in FIG. 7C, the manufacturing system 130 can receive a notification of an order placed by a customer at step 740. At step 742, the manufacturing system 130 can pre-process the order, verifying for example that the machine is able to produce the order. If the machine is not acceptable at step 744 (e.g., if the product is too large for the machine, or if the manufacturer does not have the requested material available), the manufacturer can return a response to the platform 110 to find a new manufacturer at step 746. If the machine is acceptable, the manufacturer can calculate, at step 748, an amount of time to fabricate the product and a time to start the fabrication based, for example, on the customer's requested fabrication speed. At the determined time, the manufacturer can start the production on the machine (step 750). The manufacturer can notify the platform 110 when the product is complete at step 752, and either notify the customer to pick up the product or ship the product to the customer at step 754. The manufacturer can provide feedback from the fabrication process to the platform 110 at step 756, sending, for example, the actual amount of time or materials used to manufacture the product. The platform 110 can use the manufacturer data to update models for predicting material usage and fabrication time, but the manufacturer may also compare the actual fabrication data to their predicted time to improve future predictions.

### Example Uses of a Digital Manufacturing Platform

The three-sided marketplace managed by the digital manufacturing platform 110 can be used in a wide variety of applications. In one example, independent designers can upload their designs for artwork, jewelry, tools, or any other products to the marketplace maintained by the platform 110, where customers can browse the designs, customize designs if desired, and order products for personalized manufacturing. In another example, businesses with an existing customer base can sell their products to their customers either through the platform marketplace or through a storefront maintained by the business (e.g., a website of the business). The business can upload designs for customers to browse and order (optionally with customizations), and the platform 110 can verify that the designs and any customizations are producible, select a manufacturer to fabricate the products, and ensure that the product is delivered to or picked up by the customer. Another example application allows a designer to directly order an uploaded design. The designer can upload his or her design to the platform 110, which validates the design and matches the designer to a manufacturer to produce the designer's product for the designer.

In still another example, the platform 110 can be used by a business that sells products that may need spare parts. For example, a window manufacturer may have spare parts for its windows (such as latches, locks, or pulls), or a furniture company may have spare parts for its furniture (such as brackets, extra shelves, or replacement feet). The business maintains a library of designs for the spare parts for their products through the platform 110, which can verify that the designs are producible and identify manufacturers capable of producing the designs. If a customer needs a spare part, the customer can request the spare part from the business, which in turn can order the part through the platform 110 for fabrication by a manufacturer and delivery to or pickup by the customer. Sending designs to a manufacturer when a customer orders a spare part allows the business to reduce the number of spare parts it must manufacture and store, and reduces burden on the business to ship the spare parts to the customers. Rather than storing spare parts for their products, which may be many years old and used by customers throughout the world, the business need only store designs for its spare parts. If a customer needs a spare part, the customer can order the part on demand and have the part fabricated by a manufacturer in close geographic proximity to the customer.

### Example Computing Device

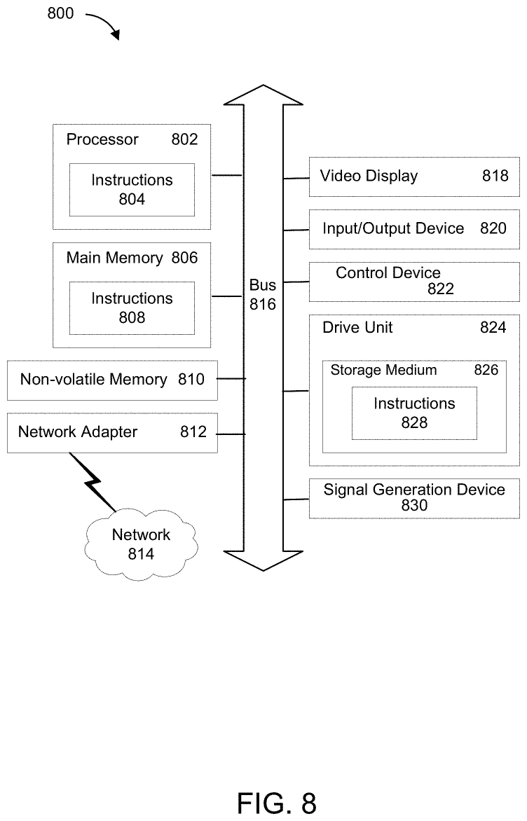

FIG. 8 is a block diagram illustrating an example of a processing system 800 in which at least some operations described herein can be implemented. For example, one or more of the digital manufacturing platform 110, product designer device 120, manufacturer device 130, or customer device 140 may be implemented as the example processing system 800. The processing system 800 may include one or more central processing units (“processors”) 802, main memory 806, non-volatile memory 810, network adapter 812 (e.g., network interfaces), video display 818, input/output devices 820, control device 822 (e.g., keyboard and pointing devices), drive unit 824 including a storage medium 826, and signal generation device 830 that are communicatively connected to a bus 816. The bus 816 is illustrated as an abstraction that represents any one or more separate physical buses, point to point connections, or both connected by appropriate bridges, adapters, or controllers. The bus 816, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 894 bus, also called “Firewire.”

In various embodiments, the processing system 800 operates as part of a user device, although the processing system 800 may also be connected (e.g., wired or wirelessly) to the user device. In a networked deployment, the processing system 800 may operate in the capacity of a server or a client machine in a client-server network environment, or as a peer machine in a peer-to-peer (or distributed) network environment.

The processing system 800 may be a server computer, a client computer, a personal computer, a tablet, a laptop computer, a personal digital assistant (PDA), a cellular phone, a processor, a web appliance, a network router, switch or bridge, a console, a hand-held console, a gaming device, a music player, network-connected (“smart”) televisions, television-connected devices, or any portable device or machine capable of executing a set of instructions (sequential or otherwise) that specify actions to be taken by the processing system 800.

While the main memory 806, non-volatile memory 810, and storage medium 826 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 828. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, may be implemented as part of an operating system or a specific application, component, program, object, module or sequence of instructions referred to as “computer programs.” The computer programs typically comprise one or more instructions (e.g., instructions 804, 808, 828) set at various times in various memory and storage devices in a computer, and that, when read and executed by one or more processing units or processors 802, cause the processing system 800 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. For example, the technology described herein could be implemented using virtual machines or cloud computing services.

Further examples of machine-readable storage media, machine-readable media, or computer-readable (storage) media include, but are not limited to, recordable type media such as volatile and non-volatile memory devices 810, floppy and other removable disks, hard disk drives, optical disks (e.g., Compact Disk Read-Only Memory (CD ROMS), Digital Versatile Disks (DVDs)), and transmission type media, such as digital and analog communication links.

The network adapter 812 enables the processing system 800 to mediate data in a network 814 with an entity that is external to the processing system 800 through any known and/or convenient communications protocol supported by the processing system 800 and the external entity. The network adapter 812 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 812 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

As indicated above, the techniques introduced here implemented by, for example, programmable circuitry (e.g., one or more microprocessors), programmed with software and/or firmware, entirely in special-purpose hardwired (i.e., non-programmable) circuitry, or in a combination or such forms. Special-purpose circuitry can be in the form of, for example, one or more application-specific integrated circuits (ASICs), programmable logic devices (PLDs), field-programmable gate arrays (FPGAs), etc.

From the foregoing, it will be appreciated that specific embodiments of the invention have been described herein for purposes of illustration, but that various modifications may be made without deviating from the scope of the invention. Accordingly, the invention is not limited except as by the appended claims.

1. A method comprising:
receiving at manufacturing platform, one or more digital design files that collectively define a digital design and include instructions readable by a fabrication machine to cause the fabrication machine to manufacture a product based on the digital design;
analyzing, by the manufacturing platform, the digital design files to determine fabrication parameters associated with manufacturing of the product based on the digital design;
selecting, by the manufacturing platform, a target fabrication machine to manufacture the product using the digital design, the target fabrication machine selected from a plurality of fabrication machines registered to the manufacturing platform based at least in part on a determined match between the fabrication parameters and specifications of the target fabrication machine; and
sending the one or more digital design files to the target fabrication machine to manufacture the product.

2. The method of claim 1, further comprising:
receiving an order for the product from a customer, the order including a customization applied by the customer to the digital design; and
modifying the one or more digital design files to include the customization;
wherein analyzing the digital design files to determine the fabrication parameters comprises analyzing the one or more modified digital design files.

3. The method of claim 2, wherein the customization comprises increasing or decreasing a dimension of the digital design, and wherein modifying the one or more digital design files comprises scaling other dimensions of the digital design in proportion to the increased or decreased dimension.

4. The method of claim 2, wherein the order further includes a delivery or timing preference, and wherein the target fabrication machine is selected further based on a determination that a manufacturer associated with the target fabrication machine can satisfy the delivery or timing preference.

5. The method of claim 2, further comprising:
calculating a basic price for the order based at least in part on the fabrication parameters;
applying, to the basic price, a price bias determined based on at least one of manufacturing capacity of the target fabrication machine, seasonality of the product, or marketing influence.

6. The method of claim 5, further comprising calculating the basic price using a pricing model, the pricing model trained using past manufacturing prices for products ordered through the manufacturing platform.

7. The method of claim 2, further comprising:
recommending, by the manufacturing platform, one or more customization parameters to apply to the digital design.

8. The method of claim 1, further comprising:
receiving a request from a manufacturer to register a new fabrication machine to the manufacturing platform;
transmitting a test design file to the manufacturer to fabricate a test object using the new fabrication machine; and
evaluating the test object fabricated by the new fabrication machine to determine specifications of the new fabrication machine.

9. The method of claim 1, wherein the target fabrication machine is configured to manufacture the product using a digital fabrication technology selected from additive manufacturing, laser cutting, three-dimensional knitting, or computer numerical control (CNC) milling.

10. A method comprising:
receiving, at a manufacturing platform, one or more digital design files that collectively define a digital design and include instructions readable by a fabrication machine to cause the fabrication machine to manufacture a product based on the digital design;
analyzing, by the manufacturing platform, producibility of the product by at least one digital manufacturing technology, the producibility analyzed based on whether a set of attributes of the one or more digital design files satisfies a set of producibility requirements for the at least one digital manufacturing technology;
if the set of attributes of the one or more digital design files does not satisfy the set of producibility requirements, generating, by the manufacturing platform, a modified digital design by automatically modifying the one or more digital design files until attributes of the modified digital design satisfy the set of producibility requirements; and
publishing the modified digital design to a browsable marketplace.

11. The method of claim 10, wherein a plurality of fabrication machines are registered to the manufacturing platform to fabricate products based on digital designs, and wherein the method further comprises:
receiving, through the browsable marketplace, a customer order for the digital design;
selecting, by the manufacturing platform, a fabrication machine of the plurality of fabrication machines to fabricate the digital design based at least in part on a determined match between the attributes of the one or more digital design files and specifications of the selected fabrication machine; and
sending the modified digital design for fabrication by the selected fabrication machine.

12. The method of claim 11, wherein analyzing the producibility of the product comprises determining whether any walls defined by the digital design have less than a first threshold thickness defined as a minimum wall thickness for any fabrication technology, and wherein selecting the selected fabrication machine comprises determining whether any of the walls have less than a second threshold thickness defined as a minimum wall thickness for a fabrication technology used by the selected fabrication machine.

13. The method of claim 11, wherein the specifications of the selected fabrication machine comprise at least one of:
a type of digital fabrication technology used by the selected fabrication machine;
a maximum or minimum size of an object producible by the selected fabrication machine; or
a feature resolution of the producible object.

14. The method of claim 10, wherein the set of producibility requirements comprises at least one of:
no double faces in the digital design;
faces of the digital design facing outwards;
faces of the digital intersecting with each other;
lines in the digital design being connected; and
walls of the digital design being at least a threshold thickness.

15. The method of claim 10, wherein publishing the modified digital design to the browsable marketplace comprises:
rendering an image of the product from the modified digital design; and
publishing the rendered image in association with the modified digital design.

16. The method of claim 10, further comprising determining, by the manufacturing platform, a maximum producibility range for the digital design, the maximum producibility range specifying a range from a minimum dimension of the digital design to a maximum dimension of the digital design at which the set of producibility requirements will be satisfied.

17. The method of claim 16, further comprising:
receiving through the browsable marketplace, an order for the product, the order including a customization applied by a customer to the digital design to increase or decrease a dimension of the digital design;
responsive to the increased or decreased dimension falling with the maximum producibility range, generating a customized digital design file that scales a plurality of dimensions of the digital design in proportion to the increased or decreased dimension; and
sending the customized digital design file for fabrication by a fabrication machine.

18. The method of claim 10, further comprising:
receiving from a customer, an order for the digital design; and
sending the modified digital design to the customer for fabricating the product using a fabrication machine associated with the customer.

19. The method of claim 10, wherein the digital fabrication technology is selected from additive manufacturing, laser cutting, three-dimensional knitting, or computer numerical control (CNC) milling.

20. A non-transitory computer-readable storage medium storing executable computer program instructions, the computer program instructions when executed by a processor causing the processor to:
receive one or more digital design files that collectively define a digital design and include instructions readable by a fabrication machine to cause the fabrication machine to manufacture a product based on the digital design;
analyze producibility of the product by at least one digital manufacturing technology, the producibility analyzed based on whether a set of attributes of the one or more digital design files satisfies a set of producibility requirements for the at least one digital manufacturing technology;
if the set of attributes of the one or more digital design files does not satisfy the set of producibility requirements, generate a modified digital design by automatically modifying the one or more digital design files until attributes of the modified digital design satisfy the set of producibility requirements;
receive an order for the product from a customer;
select a target fabrication machine to manufacture the product using the modified digital design, the target fabrication machine selected from a plurality of fabrication machines registered to the manufacturing platform based at least in part on a determined match between specifications of the target fabrication machine and fabrication parameters that are associated with manufacturing of the product based on the modified digital design; and
send the modified digital design to the target fabrication machine to manufacture the product.
